(19) United States
(12) Patent Application Publication
(10) Pub. No.: US 2023/0385775 A1
(43) Pub. Date: Nov. 30, 2023

(54) RECOMMENDATION INFORMATION PRESENTATION DEVICE, OPERATION METHOD OF RECOMMENDATION INFORMATION PRESENTATION DEVICE, OPERATION PROGRAM OF RECOMMENDATION INFORMATION PRESENTATION DEVICE

(71) Applicant: FUJIFILM Corporation, Tokyo (JP)

(72) Inventors: Asuka YAMASHITA, Saitama-shi (JP); Yuto TANAKA, Saitama-shi (JP)

(73) Assignee: FUJIFILM Corporation, Tokyo (JP)

(21) Appl. No.: 18/447,745

(22) Filed: Aug. 10, 2023

Related U.S. Application Data
(63) Continuation of application No. PCT/JP2022/000993, filed on Jan. 13, 2022.

(30) Foreign Application Priority Data
Mar. 9, 2021 (JP) 2021-037590

(51) Int. Cl. G06Q 10/1093; G06V 20/00

(52) U.S. Cl. CPC G06Q 10/1093; G06V 20/35

(57) ABSTRACT

A CPU of an image management server includes an estimation unit, an information acquisition unit, and a distribution control unit. In a case where a plurality of images, among images obtained by the user within a set period, that are bases for estimating a future event that the user is expected to experience after the set period, are equal to or larger than a first threshold value set in advance, the estimation unit estimates that the user experiences the future event after the set period. The information acquisition unit generates the recommendation information according to the estimated future event. The distribution control unit presents the recommendation information to the user.

### CROSS-REFERENCE TO RELATED APPLICATIONS

This application is a continuation application of International Application No. PCT/JP2022/000993 filed on Jan. 13, 2022, the disclosure of which is incorporated herein by reference in its entirety. Further, this application claims priority from Japanese Patent Application No. 2021-037590 filed on Mar. 9, 2021, the disclosure of which is incorporated herein by reference in its entirety.

### BACKGROUND

### 1. Technical Field

The technique of the present disclosure relates to a recommendation information presentation device, an operation method of a recommendation information presentation device, and an operation program of a recommendation information presentation device.

### 2. Description of the Related Art

Presentation of recommendation information that is appropriate for a user has been performed. For example, JP2002-041537A describes a technique of estimating, from schedule information of a future event registered by a user, recommendation information that the user may be interested in and of presenting the estimated recommendation information to the user. In JP2002-041537A, for example, in a case where a child's birthday is registered as the schedule information, information on a toy bargain sale is presented as the recommendation information.

### SUMMARY

With the recent explosive spread of user terminals with a camera function, such as smartphones and tablet terminals, most users can easily capture an image with the user terminal. The image obtained by the user in this manner may include a subject that is a basis for estimating an event that the user may experience in the future. For example, a bridal salon is shown in an image of a user who is about to get married.

The inventors of the present disclosure figure out a method of estimating recommendation information that the user may be interested in based on the image obtained by the user, instead of the schedule information described in JP2002-041537A, to save user's time and effort to register the schedule information. However, in a case where the estimation accuracy of the recommendation information based on the image is poor, the recommendation information that is irrelevant is presented and a business opportunity is missed.

In one embodiment according to the technique of the present disclosure, provided are a recommendation information presentation device, an operation method of a recommendation information presentation device, and an operation program of a recommendation information presentation device capable of presenting recommendation information that is likely to be of interest to a user without causing the user to take time and effort.

A recommendation information presentation device of the present disclosure includes a processor, and a memory connected to or built into the processor. The processor estimates, in a case where a plurality of images, among images obtained by a user within a period set in advance, that are bases for estimating a future event that the user is expected to experience after the period are equal to or larger than a first threshold value set in advance, that the user experiences the future event after the period, generates recommendation information according to the estimated future event, and presents the recommendation information to the user.

It is preferable that the processor determines whether or not the image is the basis for estimating the future event based on at least any one of an analysis result of the image or information attached to the image.

It is preferable that the processor estimates, in a case where all images related to specific related events, which are at least two of related events which are events related to the future event, are equal to or larger than a second threshold value set in advance, that the user experiences the future event after the period.

It is preferable that the processor stops, in a case where a frequency of adoption of the recommendation information by the user satisfies a condition set in advance, the presentation of the recommendation information.

It is preferable that the processor preferentially presents the recommendation information that is relatively frequently adopted by another user.

It is preferable that the other user is a user whose attribute is similar to or matches an attribute of the user to which the recommendation information is presented.

It is preferable that the other user is a user whose event experience order is similar to or matches an event experience order of the user to which the recommendation information is presented.

It is preferable that the processor selects the recommendation information according to the estimated future event from a plurality of pieces of the recommendation information registered in advance.

An operation method of a recommendation information presentation device of the present disclosure includes estimating, in a case where a plurality of images, among images obtained by a user within a period set in advance, that are bases for estimating a future event that the user is expected to experience after the period are equal to or larger than a first threshold value set in advance, that the user experiences the future event after the period, generating recommendation information according to the estimated future event, and presenting the recommendation information to the user.

An operation program of a recommendation information presentation device of the present disclosure that causes a computer to execute processing includes estimating, in a case where a plurality of images, among images obtained by a user within a period set in advance, that are bases for estimating a future event that the user is expected to experience after the period are equal to or larger than a first threshold value set in advance, that the user experiences the future event after the period, generating recommendation information according to the estimated future event, and presenting the recommendation information to the user.

According to the technique of the present disclosure, it is possible to provide the recommendation information presentation device, the operation method of the recommendation information presentation device, and the operation program of the recommendation information presentation device capable of presenting the recommendation information that is likely to be of interest to the user without causing the user to take time and effort.

### BRIEF DESCRIPTION OF THE DRAWINGS

Exemplary embodiments according to the technique of the present disclosure will be described in detail based on the following figures, wherein:

FIG. 1 is a diagram showing an image management system;

FIG. 2 is a diagram showing information exchanged between an image management server and a user terminal;

FIG. 3 is a diagram showing the inside of an image DB;

FIG. 4 is a diagram showing the inside of a recommendation information DB and a content of recommendation information;

FIG. 5 is a block diagram showing a computer constituting the image management server and the user terminal;

FIG. 6 is a block diagram showing a processing unit of a CPU of the image management server;

FIG. 7 is a diagram showing processing of an analysis unit;

FIG. 8 is a table showing estimated reference information;

FIG. 9 is a diagram showing processing of an estimation unit;

FIG. 10 is a diagram showing another example of processing of the estimation unit;

FIG. 11 is a diagram showing processing of the estimation unit;

FIG. 12 is a diagram showing another example of processing of the estimation unit;

FIG. 13 is a diagram showing an information acquisition request;

FIG. 14 is a diagram showing another example of the information acquisition request;

FIG. 15 is a block diagram showing a processing unit of a CPU of a user terminal;

FIG. 16 is a diagram showing an image list display screen;

FIG. 17 is a diagram showing the image list display screen on which a list of recommendation information is displayed;

FIG. 18 is a flowchart showing a processing procedure of an image management server;

FIG. 19 is a diagram showing an aspect in which imaging position information is used;

FIG. 20 is a diagram showing an aspect in which tag information is used;

FIG. 21 is a diagram showing processing of an estimation unit according to a second embodiment;

FIG. 22 is a diagram showing another example of processing of the estimation unit according to the second embodiment;

FIG. 23 is a diagram showing a third embodiment in which the presentation of the recommendation information is stopped in a case where the number of times the user adopts the recommendation information satisfies a distribution stop condition set in advance;

FIG. 24 is a diagram showing recommendation information according to a 4_1st embodiment;

FIG. 25 is a diagram showing a state in which a display order in a list of a plurality of pieces of recommendation information is set in descending order of the cumulative number of times of adoption;

FIG. 26 is a diagram showing recommendation information according to a 4_2nd embodiment;

FIG. 27 is a diagram showing a state in which a display order in a list of a plurality of pieces of recommendation information is set in descending order of the cumulative number of times of adoption for an attribute that matches a user to which the recommendation information is presented;

FIG. 28 is a diagram showing recommendation information according to a 4_3rd embodiment;

FIG. 29 is a diagram showing a state in which a display order in a list of a plurality of pieces of recommendation information is set in descending order of the cumulative number of times of adoption for an event experience order that matches a user to which the recommendation information is presented;

FIG. 30 is a table showing estimated reference information of a future event “child-rearing”;

FIG. 31 is a table showing estimated reference information of a future event “end of life”; and

FIG. 32 is a table showing estimated reference information of a future event “employment”.

### DETAILED DESCRIPTION

### First Embodiment

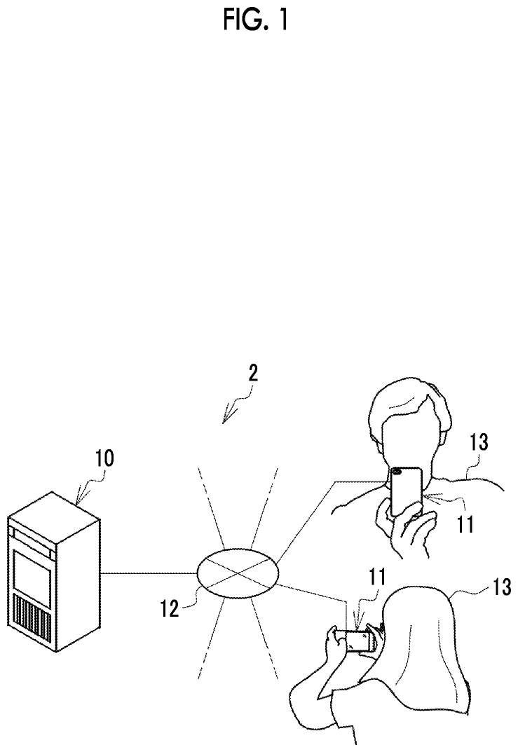

As shown in FIG. 1 as an example, an image management system 2 comprises an image management server 10 and a plurality of user terminals 11. The image management server 10 and the user terminal 11 are communicably connected via a network 12. The network 12 is, for example, a wide area network (WAN) such as the Internet and a public communication network.

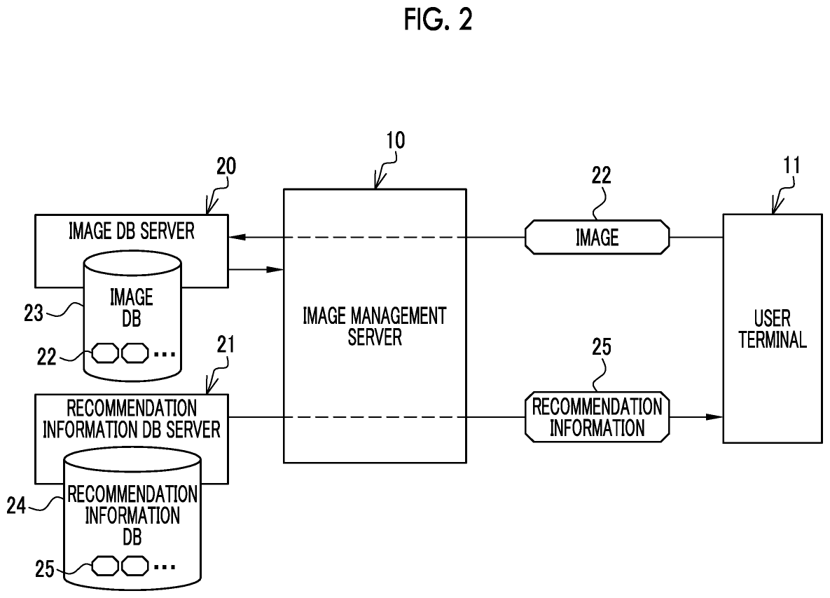

The image management server 10 is, for example, a server computer or a workstation, and is an example of a “recommendation information presentation device” according to the technique of the present disclosure. The user terminal 11 is a terminal owned by each user 13. The user terminal 11 has at least a function of reproducing and displaying an image 22 (refer to FIG. 2 and the like) and a function of transmitting the image 22 to the image management server 10. The user terminal 11 is, for example, a smartphone, a tablet terminal, a personal computer, and the like.

As shown in FIG. 2 as an example, an image database (hereinafter abbreviated as DB) server 20 and a recommendation information DB server 21 are connected to the image management server 10 via a network (not shown) such as a local area network (LAN). The image management server 10 transmits the image 22 from the user terminal 11 to the image DB server 20. The image DB server 20 has an image DB 23. The image DB server 20 accumulates and manages the image 22 from the image management server 10 in the image DB 23. Further, the image DB server 20 transmits the image 22 accumulated in the image DB 23 to the image management server 10 in response to a request from the image management server 10.

The recommendation information DB server 21 has a recommendation information DB 24. Recommendation information 25 is stored in the recommendation information DB 24. The recommendation information 25 is information such as a product, a store, and a facility recommended to the user 13. The recommendation information 25 is registered in advance by an employee of a product seller or an employee of a store or facility. The recommendation information DB server 21 transmits the recommendation information 25 of the recommendation information DB 24 to the image management server 10 in response to a request from the image management server 10. The image management server 10 distributes the recommendation information 25 to the user terminal 11.

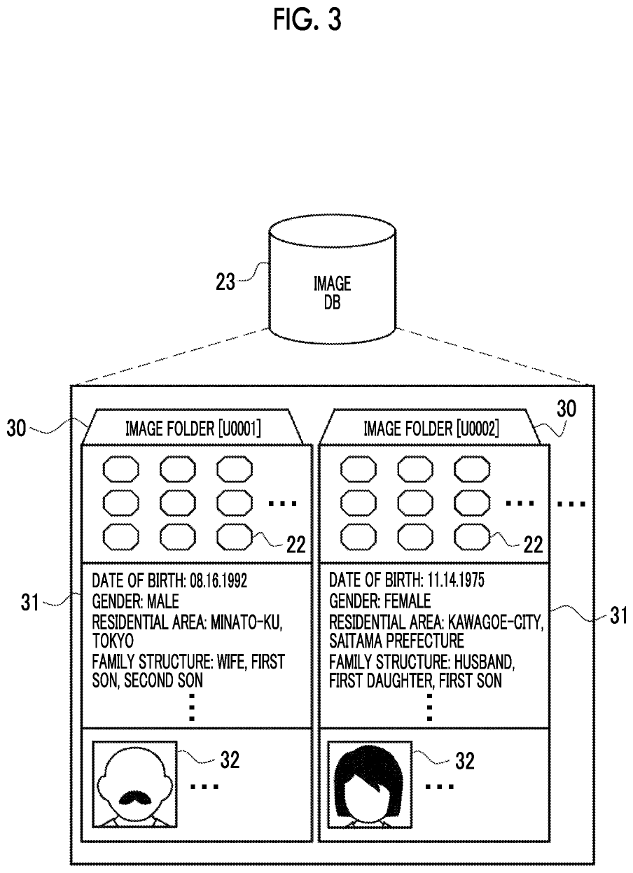

As shown in FIG. 3 as an example, a plurality of image folders 30 are provided in the image DB 23. The image folder 30 is a folder addressed to each user 13 one by one and is a folder unique to one user 13. Therefore, the image folders 30 are provided for the number of users 13. A user identification data (ID) for uniquely identifying the user 13, such as [U0001] or [U0002], is associated with the image folder 30.

The image 22 owned by the user 13 is stored in the image folder 30. The image 22 owned by the user 13 includes an image captured by the user 13 using a camera function of the user terminal 11. Further, the image 22 owned by the user 13 also includes an image captured by using a digital camera other than the user terminal 11. Furthermore, the image 22 owned by the user 13 includes an image received by the user 13 from another user 13 such as a friend or a family member, an image downloaded by the user 13 on an Internet site, an image read by the user 13 with a scanner, and the like. The image 22 in the image folder 30 is periodically synchronized with the image 22 stored locally in the user terminal 11.

The image folder 30 is associated with attribute information 31 of the user 13 and a face image 32. The attribute information 31 and the face image 32 are registered by the user 13. The attribute information 31 includes a date of birth, a gender, a residential area, a family structure, and the like of the user 13. The residential area is a combination of a prefecture and a municipality. The face image 32 is an image showing a face of the user 13 oneself, a family member and/or a relative of the user 13, a lover and/or a friend of the user 13, or the like. A relationship with the user 13, such as a “parent”, a “grandchild”, a “lover”, or a “friend”, is also registered in the face image 32.

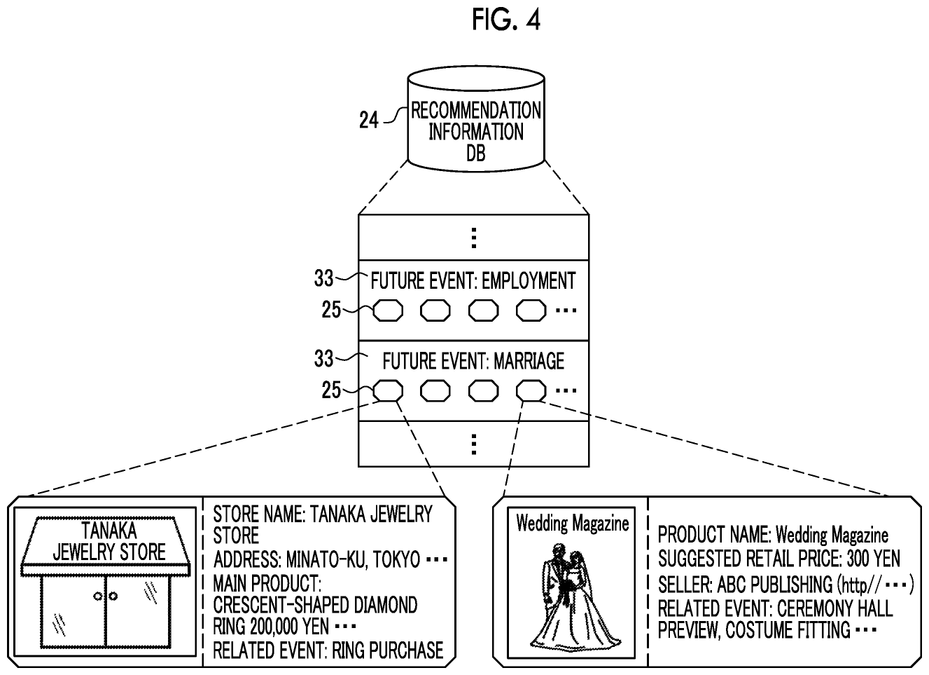

As shown in FIG. 4 as an example, the recommendation information DB 24 is divided into a plurality of categories 33, and each category 33 stores a plurality of pieces of recommendation information 25. The category 33 is provided for each future event that the user 13 may experience. The future event is a so-called life event such as “employment” or “marriage” as an example.

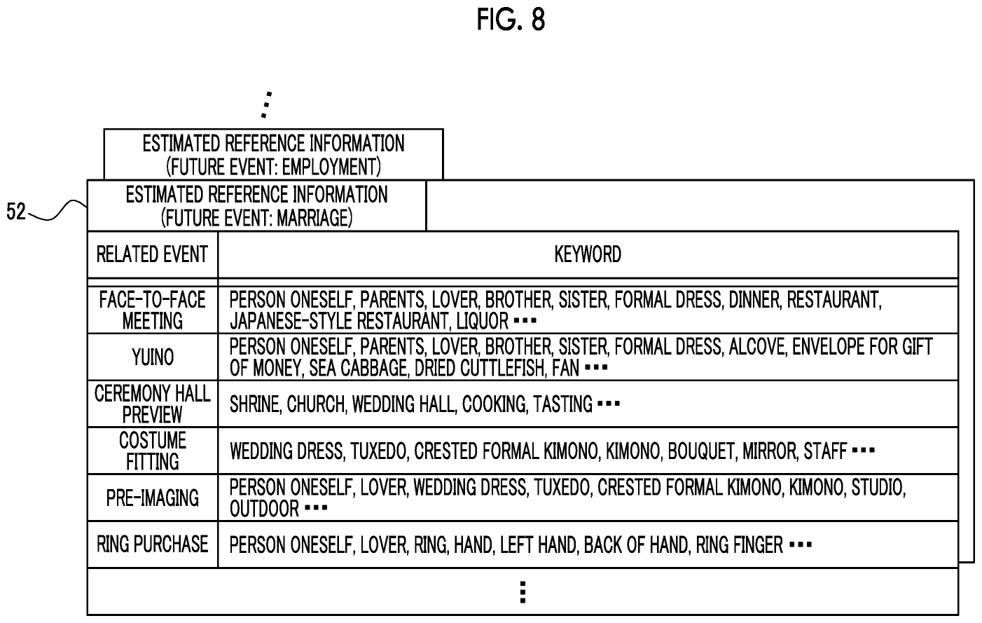

The recommendation information 25 includes the recommendation information 25 of product and the recommendation information 25 of store or facility. In the recommendation information 25 of product, an image of product, a name of product, a suggested retail price, a seller, a related event related to the product, and the like are registered. In the recommendation information 25 of store or facility, an image of store or facility, a store or facility name, an address, a main product, a related event related to the store or facility, and the like are registered. The related event is an event related to the future event. For example, in a case where the future event is “marriage”, the related events are “ceremony hall preview”, “costume fitting”, “ring purchase”, and the like (refer to also FIG. 8). In FIG. 4, a marriage information magazine is illustrated as the product, and a jewelry store is illustrated as the store or facility.

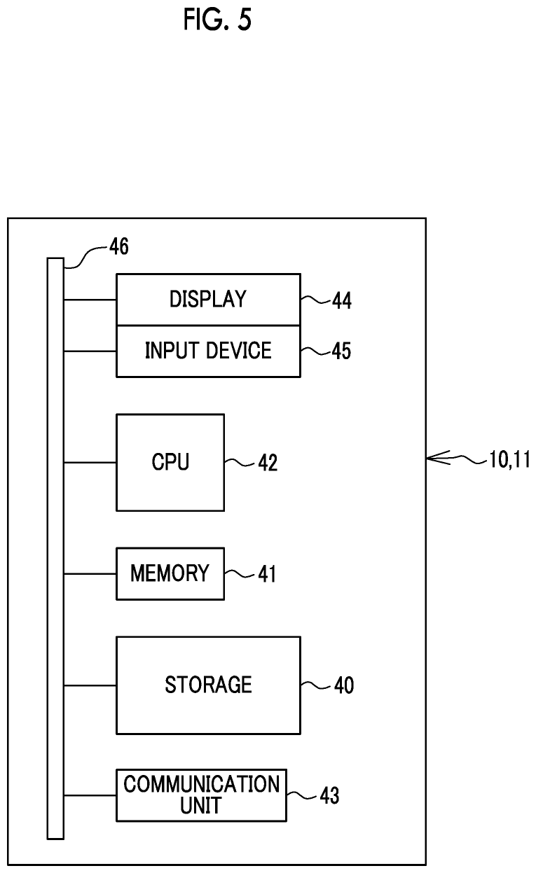

As shown in FIG. 5 as an example, the computers constituting the image management server 10 and the user terminal 11 have basically the same configuration and comprise a storage 40, a memory 41, a central processing unit (CPU) 42, a communication unit 43, a display 44, and an input device 45. The above parts are interconnected via a busline 46.

The storage 40 is a hard disk drive built into the computers constituting the image management server 10 and the user terminal 11, or connected through a cable or a network. Alternatively, the storage 40 is a disk array in which a plurality of hard disk drives are continuously mounted. The storage 40 stores a control program such as an operating system, various application programs (hereinafter abbreviated as AP), various pieces of data accompanying these programs, and the like. A solid state drive may be used instead of the hard disk drive.

The memory 41 is a work memory for the CPU 42 to execute the processing. The CPU 42 loads the program stored in the storage 40 into the memory 41 to execute the processing according to the program. Accordingly, the CPU 42 integrally controls each part of the computer. The CPU 42 is an example of a “processor” according to the technique of the present disclosure. The memory 41 may be built into the CPU 42.

The communication unit 43 is a network interface that controls transmission of various types of information via the network 12 or the like. The display 44 displays various screens. The various screens are provided with an operation function by a graphical user interface (GUI). The computers constituting the image management server 10 and the user terminal 11 receive an input of an operation instruction from the input device 45 through the various screens. The input device 45 is a keyboard, a mouse, a touch panel, and the like.

In the following description, a suffix “A” is assigned to each part of the computer constituting the image management server 10, and a suffix “B” is assigned to each part of the computer constituting the user terminal 11 as reference numerals to distinguish the computers.

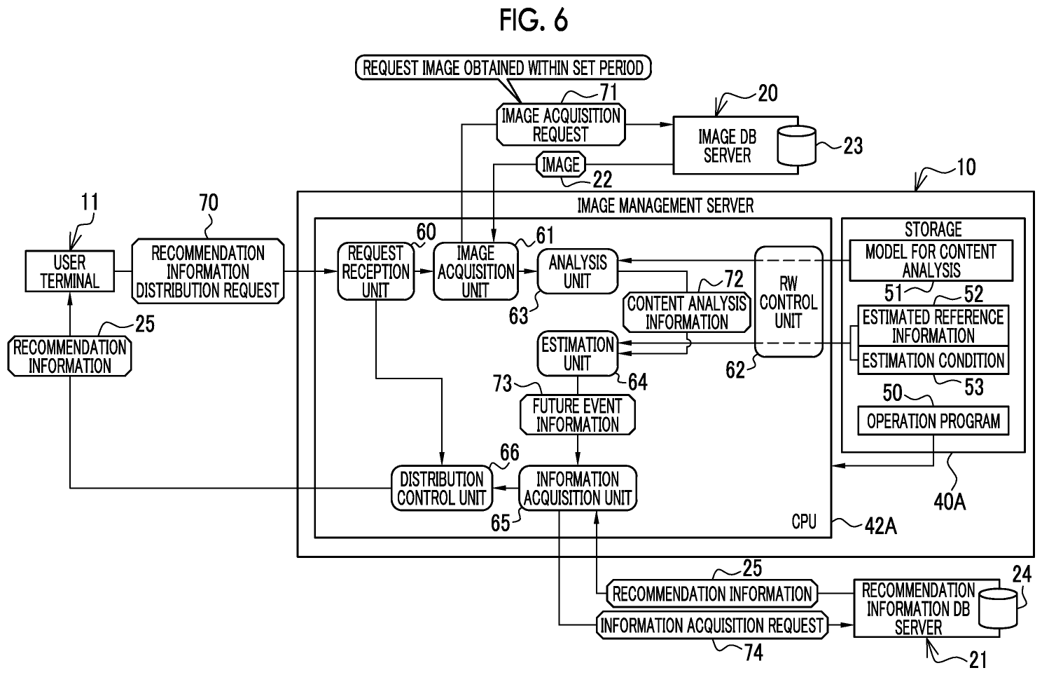

As shown in FIG. 6 as an example, an operation program 50 is stored in a storage 40A of the image management server 10. The operation program 50 is an AP for causing the computer constituting the image management server 10 to function as the “recommendation information presentation device” according to the technique of the present disclosure. That is, the operation program 50 is an example of an “operation program of recommendation information presentation device” according to the technique of the present disclosure. In addition to the operation program 50, the storage 40A also stores a machine learning model for content analysis (hereinafter abbreviated as model for content analysis) 51, estimated reference information 52, and an estimation condition 53.

In a case where the operation program 50 is started, a CPU 42A of the image management server 10 cooperates with the memory 41 and the like to function as a request reception unit 60, an image acquisition unit 61, a read/write (hereinafter abbreviated as RW) control unit 62, an analysis unit 63, an estimation unit 64, an information acquisition unit 65, and a distribution control unit 66.

The request reception unit 60 receives various requests from the user terminal 11. For example, the request reception unit 60 receives a recommendation information distribution request 70. The recommendation information distribution request 70 requests the distribution of the recommendation information 25. The recommendation information distribution request 70 is automatically transmitted from the user terminal 11 for each period set in advance (hereinafter referred to as set period). The set period is, for example, one week, two weeks, one month, or half a year.

The recommendation information distribution request 70 includes a user ID and a terminal ID. The terminal ID is an ID of the user terminal 11 that has transmitted the recommendation information distribution request 70. The request reception unit 60 outputs the user ID of the recommendation information distribution request 70 to the image acquisition unit 61. Further, the request reception unit 60 outputs the terminal ID of the recommendation information distribution request 70 to the distribution control unit 66.

In a case where the recommendation information distribution request 70 is input from the request reception unit 60, the image acquisition unit 61 transmits image acquisition request 71 to the image DB server 20. The image acquisition request 71 is a copy of the user ID of the recommendation information distribution request 70, and has a content requesting the image 22 obtained by the user 13 of the user ID within the set period. For example, in a case where the set period is two weeks and a date on which the image acquisition request 71 is transmitted is February 4, the image acquisition request 71 has a content requesting the image 22 obtained by the user 13 to February 4 from January 22, two weeks before February 4.

The image DB server 20 reads out the image 22 in response to the image acquisition request 71 from the image DB 23, and transmits the readout image 22 to the image management server 10. The image acquisition unit 61 acquires the image 22 transmitted from the image DB server 20 in response to the image acquisition request 71. The image acquisition unit 61 outputs the acquired image 22 to the analysis unit 63. Although not shown, the image acquisition unit 61 acquires the attribute information 31 and the face image 32, in addition to the image 22. The image acquisition unit 61 outputs the attribute information 31 to the information acquisition unit 65 and outputs the face image 32 to the estimation unit 64.

The RW control unit 62 controls the storage of various types of information in the storage 40A and the readout of various types of information in the storage 40A. For example, the RW control unit 62 reads out the model for content analysis 51 from the storage 40A and outputs the readout model for content analysis 51 to the analysis unit 63. Further, the RW control unit 62 reads out the estimated reference information 52 and the estimation condition 53 from the storage 40A and outputs the readout estimated reference information 52 and estimation condition 53 to the estimation unit 64.

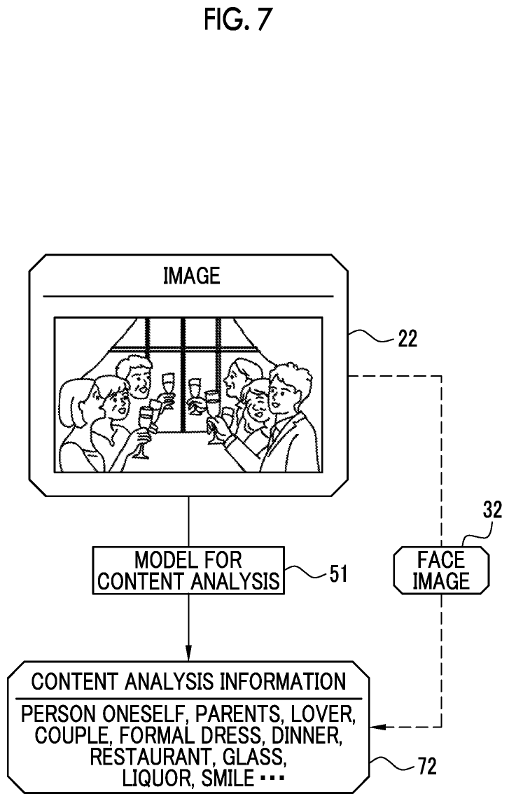

The analysis unit 63 generates content analysis information 72 from the image 22 by using the model for content analysis 51. The content analysis information 72 is information obtained by analyzing the content of the image 22 (refer to also FIG. 7). The analysis unit 63 outputs the content analysis information 72 to the estimation unit 64. The content analysis information 72 is an example of an “analysis result” according to the technique of the present disclosure.

The estimation unit 64 determines whether or not the image 22 from the image DB server 20 is the image 22 that is a basis for estimating the future event, based on the estimated reference information 52 and the content analysis information 72. The estimation unit 64 determines whether or not the image 22 determined to be the basis for estimating the future event satisfies the estimation condition 53. In a case where the image 22 determined to be the basis for estimating the future event is determined to satisfy the estimation condition 53, the estimation unit 64 estimates that the user 13 experiences the future event after the set period. The estimation unit 64 outputs, to the information acquisition unit 65, information (hereinafter referred to as future event information) 73 of the future event estimated to be experienced by the user 13 after the set period.

The information acquisition unit 65 transmits, to the recommendation information DB server 21, information acquisition request 74 requesting the recommendation information 25 according to future event information 73. The recommendation information DB server 21 reads out, from the recommendation information DB 24, the recommendation information 25 requested in the information acquisition request 74, and transmits the readout recommendation information 25 to the image management server 10. The information acquisition unit 65 acquires the recommendation information 25 transmitted from the recommendation information DB server 21. In this manner, the information acquisition unit 65 selects the recommendation information 25 according to the future event information 73 from the plurality of pieces of recommendation information 25 registered in advance in the recommendation information DB 24. The information acquisition unit 65 outputs the acquired recommendation information 25 to the distribution control unit 66. The selection of the recommendation information 25 by the information acquisition unit 65 is an example of “generate recommendation information” and “generating recommendation information” according to the technique of the present disclosure.

The distribution control unit 66 performs control of distributing the recommendation information 25 from the information acquisition unit 65 to the user terminal 11 that is a transmission source of the recommendation information distribution request 70. In this case, the distribution control unit 66 specifies the user terminal 11, which is the transmission source of the recommendation information distribution request 70, based on the terminal ID from the request reception unit 60. The distribution control unit 66 distributes the recommendation information 25 to the user terminal 11 to present the recommendation information 25 to the user 13.

As shown in FIG. 7 as an example, the analysis unit 63 inputs the image 22 to the model for content analysis 51 and outputs the content analysis information 72 from the model for content analysis 51. The model for content analysis 51 is, for example, a combination of a convolutional neural network (CNN) that extracts a feature amount of the image 22 and a recurrent neural network (RNN) that extracts a feature amount of a word. The model for content analysis 51 outputs a plurality of words representing the content of the input image 22 as the content analysis information 72. A short sentence (caption) representing the content of the input image 22 may be output as the content analysis information 72.

Further, the analysis unit 63 determines whether or not a person whose face image 32 is registered, such as the user 13 oneself, a family member and/or a relative of the user 13, or a lover and/or a friend of the user 13, is shown in the image 22. In a case where the person whose face image 32 is registered is determined to be shown in the image 22, a word representing that fact is included in the content analysis information 72. For example, in a case where the user 13 oneself is shown in the image 22, a word “person oneself” is included in the content analysis information 72. Further, in a case where the lover of the user 13 is shown in the image 22, a word “lover” is included in the content analysis information 72.

FIG. 7 shows an example of the image 22 obtained by capturing a state of face-to-face meeting between two families before marriage. The figure shows an example of outputting, for the image 22, the content analysis information 72 having a content of “person oneself, parents, lover, couple, formal dress, dinner, restaurant, glass, liquor, smile,”.

As shown in FIG. 8 as an example, the estimated reference information 52 is prepared for each future event. A keyword for each related event of the future event is registered in the estimated reference information 52. An example of the related event includes an event that the user 13 may generally experience prior to the future event. Further, the related events are registered in a general order that the user 13 may follow. Therefore, not all users 13 experience all related events. Further, not all users 13 experience the related events in this order.

FIG. 8 illustrates the estimated reference information 52 for the future event “marriage”. The related events in this case include “face-to-face meeting”, “Yuino(Japanese traditional betrothal ceremony)”, “ceremony hall preview”, “costume fitting”, “pre-imaging”, and “ring purchase”. Further, examples of the keywords include “person oneself, parents, lover, brother, sister, formal dress, dinner, restaurant, Japanese-style restaurant, liquor,” of the related event “face-to-face meeting”, and “shrine, church, wedding hall, cooking, tasting,” of the related event “ceremony hall preview”.

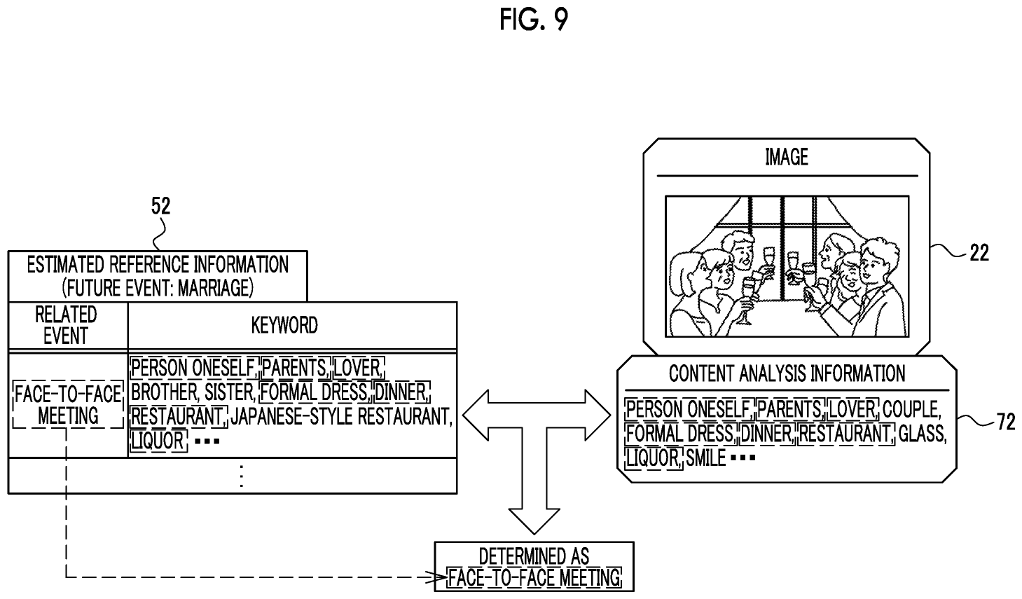

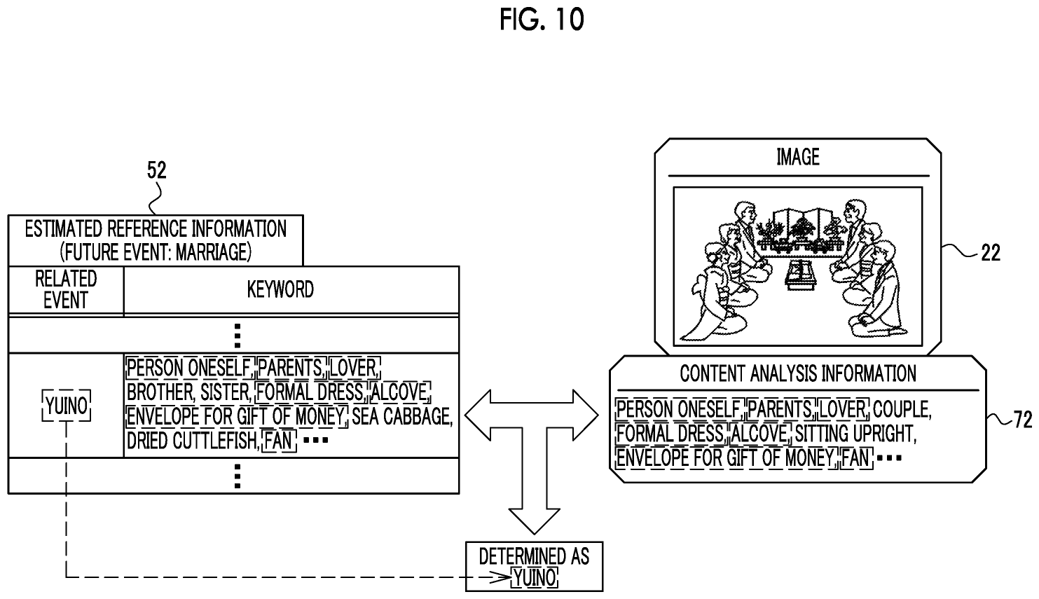

As shown in FIGS. 9 and 10 as an example, the estimation unit 64 collates the keyword registered in each related event of the estimated reference information 52 of each future event with the word included in the content analysis information 72. Then, it is checked whether or not a collation result satisfies a condition set in advance for each future event and each related event. In a case where there is a related event for which the collation result satisfies the condition, the estimation unit 64 determines that the event shown in the image 22 is the related event. The image 22 determined to show the related event in this manner is, that is, the image 22 that is the basis for estimating the future event. The condition is, for example, that the number of matches of the keyword registered in the estimated reference information 52 and the word included in the content analysis information 72 is five or more. Alternatively, the condition may be, for example, that the number of matches of the keyword registered in the estimated reference information 52 and the word included in the content analysis information 72 is 70% or more of the number of keywords registered in the estimated reference information 52.

FIG. 9 illustrates the image 22 obtained by capturing the state of the face-to-face meeting shown in FIG. 7. In this case, in the keywords registered in the related event “face-to-face meeting” of the estimated reference information 52 of the future event “marriage” and the words included in the content analysis information 72, “person oneself”, “parents”, “lover”, “formal dress”, “dinner”, “restaurant”, “liquor”, and the like match. Therefore, the estimation unit 64 determines that the event shown in the image 22 is “face-to-face meeting”.

FIG. 10 illustrates the image 22 obtained by capturing the state of the Yuino. The content analysis information 72 has a content of “person oneself, parents, lover, couple, formal dress, alcove, sitting upright, envelope for gift of money, fan,”. In this case, in the keywords registered in the related event “Yuino” of the estimated reference information 52 of the future event “marriage” and the words included in the content analysis information 72, “person oneself”, “parents”, “lover”, “formal dress”, “alcove”, “envelope for gift of money”, “fan”, and the like match. For this reason, the estimation unit 64 determines that the event shown in the image 22 is “Yuino”.

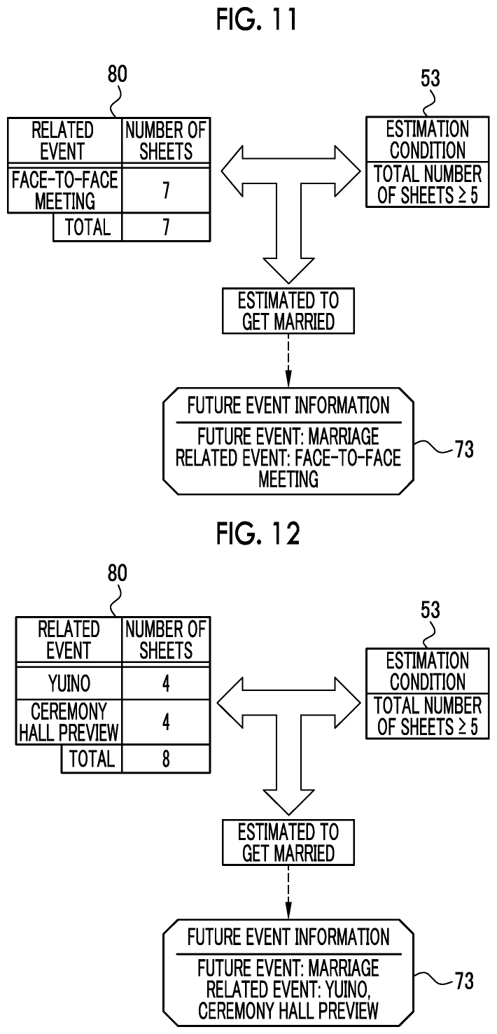

As shown in Table 80 of FIGS. 11 and 12 as an example, the estimation unit 64 counts a total number of sheets of the image 22 that is determined to show the related event, that is, is the basis for estimating the future event. The estimation unit 64 determines whether or not the total number of sheets of the image 22 that is the basis for estimating the future event satisfies the estimation condition 53. In the estimation condition 53, the total number of sheets of the image 22 that is the basis for estimating the future event is equal to or larger than a first threshold value. FIGS. 11 and 12 illustrate a case where the first threshold value is five (estimation condition: total number of sheets ≤5).

In a case where the total number of sheets of the image 22 that is the basis for estimating the future event is equal to or larger than the first threshold value, the estimation unit 64 estimates that the user 13 experiences the future event after the set period. The future event information 73 including the estimated future event and the related event on which the estimation is based is output to the information acquisition unit 65. On the other hand, in a case where the total number of sheets of the image 22 that is the basis for estimating the future event is less than the first threshold value, the estimation unit 64 estimates that the user 13 does not experience the future event after the set period. In this case, the estimation unit 64 does not output the future event information 73 to the information acquisition unit 65.

FIG. 11 illustrates a case where the total number of sheets of the image 22 that is the basis for estimating the future event is seven sheets determined to show the related event “face-to-face meeting”. In this case, the estimation unit 64 estimates that the user 13 gets married after the set period. The future event information 73 including the future event “marriage” and the related event “face-to-face meeting” is output to the information acquisition unit 65.

FIG. 12 illustrates a case where the total number of sheets of the image 22 that is the basis for estimating the future event is eight sheets including four sheets determined to show the related event “Yuino” and four sheets determined to show “ceremony hall preview”. In this case, the estimation unit 64 estimates that the user 13 gets married after the set period. The future event information 73 including the future event “marriage” and the related events “Yuino” and “ceremony hall preview” is output.

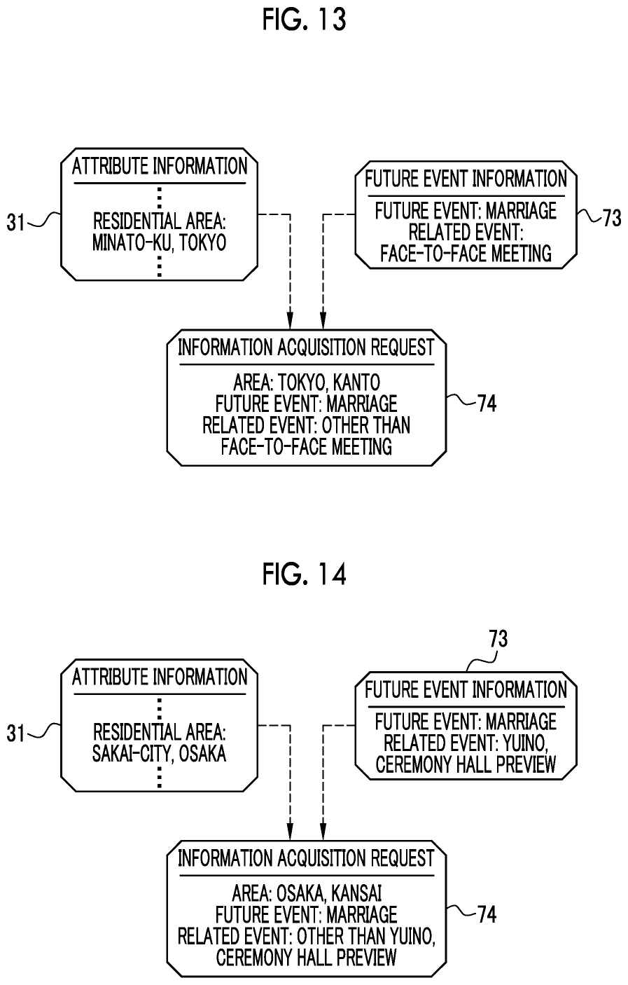

As shown in FIGS. 13 and 14 as an example, the information acquisition unit 65 generates the information acquisition request 74 based on the attribute information 31 and the future event information 73. More specifically, the information acquisition unit 65 generates the information acquisition request 74 in which an area corresponding to the residential area of the attribute information 31, the future event of the future event information 73, and an event other than the related event of the future event information 73 are registered. Therefore, the information acquisition request 74 has a content requesting the recommendation information 25 that is stored in the future event category 33 of the future event information 73 and in which the area corresponding to the residential area of the attribute information 31 is registered and the event other than the related event of the future event information 73 is registered.

FIG. 13 illustrates a case where the residential area of the attribute information 31 is “Minato-ku, Tokyo” and the future event information 73 is the information shown in FIG. 11. In this case, the information acquisition unit 65 generates the information acquisition request 74 in which “Tokyo, Kanto” is registered as the area corresponding to the residential area of the attribute information 31, “marriage” is registered as the future event, and “event other than face-to-face meeting” is registered as the related event.

FIG. 14 illustrates a case where the residential area of the attribute information 31 is “Sakai City, Osaka Prefecture” and the future event information 73 is the information shown in FIG. 12. In this case, the information acquisition unit 65 generates the information acquisition request 74 in which “Kansai, Osaka Prefecture” is registered as the area corresponding to the residential area of the attribute information 31, “marriage” is registered as the future event, and “event other than Yuino, ceremony hall preview” is registered as the related event.

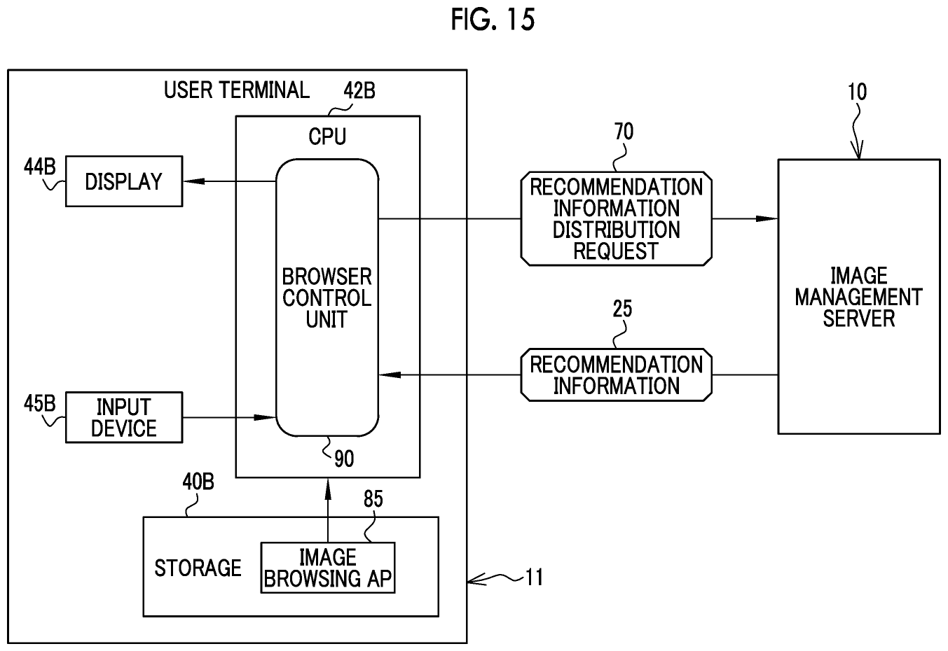

As shown in FIG. 15 as an example, a storage 40B of the user terminal 11 stores an image browsing AP 85. In a case where the image browsing AP 85 is executed and a web browser dedicated to the image browsing AP 85 is started, a CPU 42B of the user terminal 11 cooperates with the memory 41 and the like to function as a browser control unit 90. The browser control unit 90 controls the operation of the web browser.

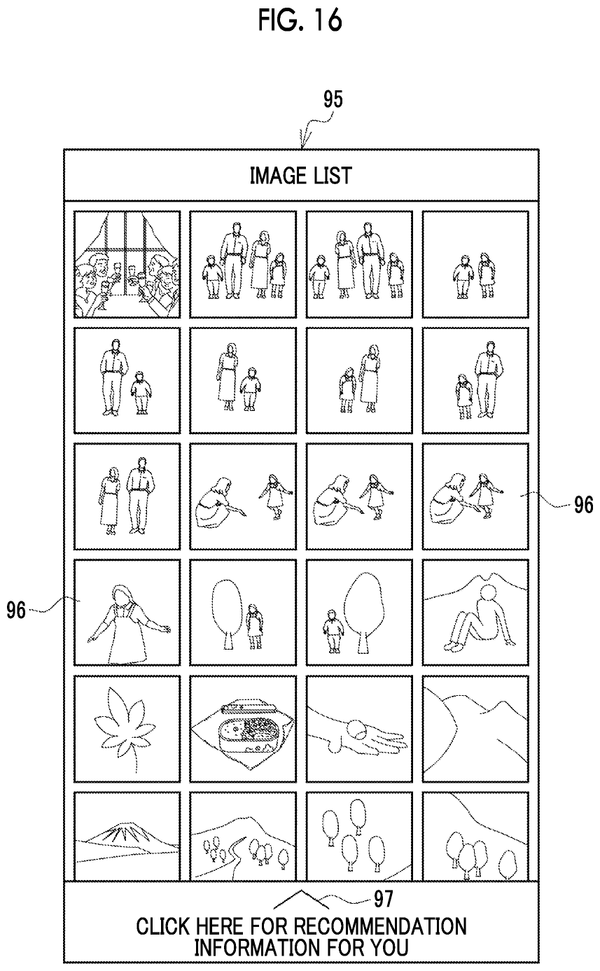

The browser control unit 90 receives various operation instructions to be input from an input device 45B by the user 13 through the various screens. The browser control unit 90 transmits a request in response to the operation instruction or the like to the image management server 10. For example, the browser control unit 90 transmits the recommendation information distribution request 70 to the image management server 10 for each set period. Further, the browser control unit 90 generates various screens such as an image list display screen 95 (refer to FIG. 16 and the like) that displays the images 22 as a list and displays the generated screens on a display 44B.

FIG. 16 shows an example of the image list display screen 95. On the image list display screen 95, thumbnail images 96 obtained by cutting out the image 22 into a square shape are arranged at equal intervals in vertical and horizontal directions.

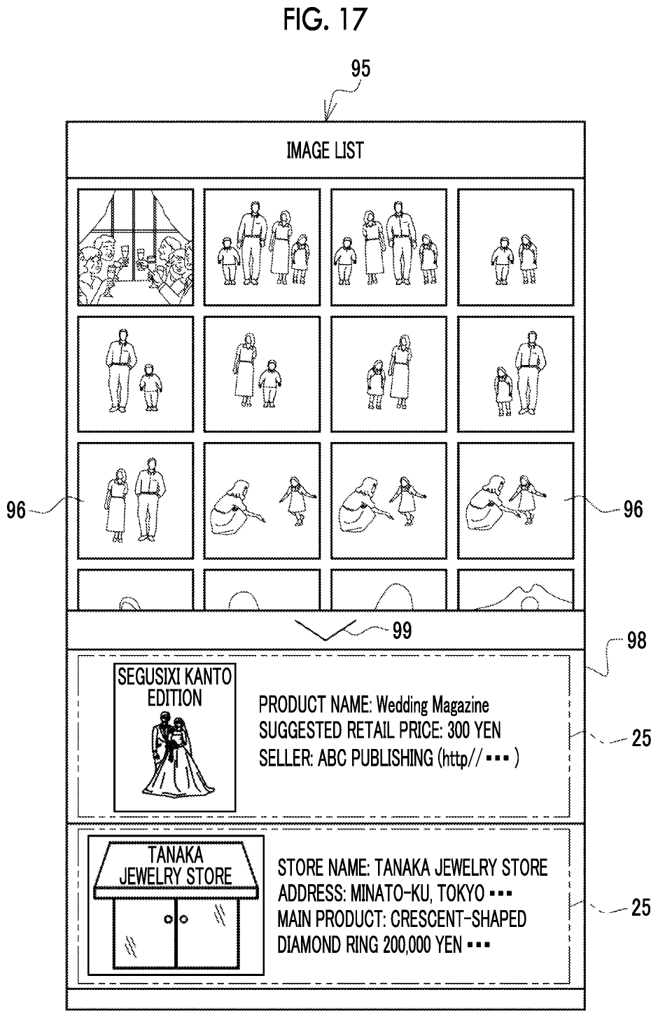

In a case where the recommendation information 25 is distributed from the image management server 10, a display button 97 for displaying the recommendation information 25 is provided on a lower part of the image list display screen 95. In a case where the display button 97 is selected, as shown in FIG. 17 as an example, the browser control unit 90 displays a list 98 of the recommendation information 25 on the image list display screen 95. The recommendation information 25 in the list 98 can be selected. In a case where the recommendation information 25 is selected, the entire content of the recommendation information 25 is displayed in an enlarged manner.

A non-display button 99 is provided on an upper part of the list 98. In a case where the non-display button 99 is selected, the browser control unit 90 hides the list 98 and returns the image list display screen 95 to the display state shown in FIG. 16.

FIG. 17 shows an example in which the future event estimated to be experienced by the user 13 is “marriage” and the recommendation information 25 of the marriage information magazine, the recommendation information 25 of the jewelry store, and the like are displayed in the list 98.

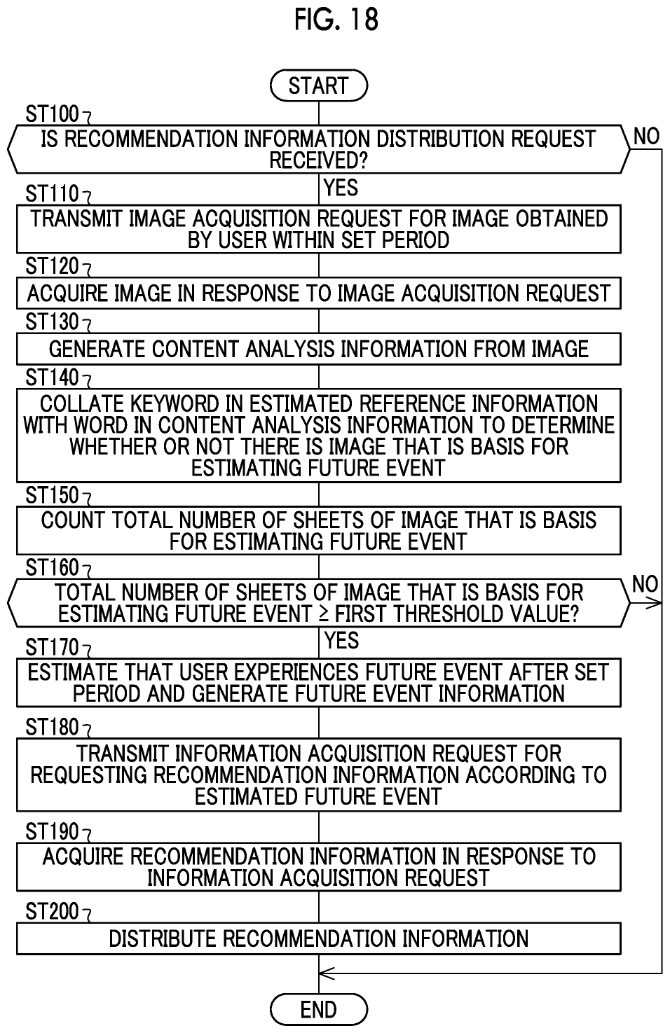

Next, an action of the above configuration will be described with reference to a flowchart shown in FIG. 18 as an example. In a case where the operation program 50 is started, the CPU 42A of the image management server 10 functions as the request reception unit 60, the image acquisition unit 61, the RW control unit 62, the analysis unit 63, the estimation unit 64, the information acquisition unit 65, and a distribution control unit 66, as shown in FIG. 6.

In a case where the image browsing AP 85 is started, the CPU 42B of the user terminal 11 functions as the browser control unit 90, as shown in FIG. 15.

The recommendation information distribution request 70 is issued from the browser control unit 90 for each set period. The recommendation information distribution request 70 is transmitted from the user terminal 11 to the image management server 10.

As shown in FIG. 18, in a case where the request reception unit 60 receives the recommendation information distribution request 70 from the user terminal 11 (YES in step ST100), the image acquisition request 71 with a content requesting the image 22 obtained by the user 13 within the set period is transmitted from the image acquisition unit 61 to the image DB server 20 (step ST110). The image 22 transmitted from the image DB server 20 in response to the image acquisition request 71 is acquired by the image acquisition unit 61 (step ST120). The image 22 is output from the image acquisition unit 61 to the analysis unit 63.

As shown in FIG. 7, the analysis unit 63 generates the content analysis information 72 from the image 22 by using the face image 32 and the model for content analysis 51 (step ST130). The content analysis information 72 is output from the analysis unit 63 to the estimation unit 64.

As shown in FIGS. 9 and 10, in the estimation unit 64, the keyword registered in the estimated reference information 52 is collated with the word included in the content analysis information 72. Based on a collation result, determination is made whether or not the image 22 from the image DB server 20 is the image 22 that is the basis for estimating the future event (step ST140).

As shown in FIGS. 11 and 12, the estimation unit 64 counts the total number of sheets of the image 22 that is the basis for estimating the future event (step ST150). The total number of sheets of the image 22 that is the basis for estimating the future event is compared with the first threshold value of the estimation condition 53.

In a case where the total number of sheets of the image 22 that is the basis for estimating the future event is equal to or larger than the first threshold value (YES in step ST160), the estimation unit 64 estimates that the user 13 experiences the future event after the set period and generates the future event information 73 (step ST170). The future event information 73 is output from the estimation unit 64 to the information acquisition unit 65.

As shown in FIGS. 13 and 14, the information acquisition request 74 according to the attribute information 31 and the future event information 73 is transmitted from the information acquisition unit 65 to the recommendation information DB server 21 (step ST180). The recommendation information 25 transmitted from the recommendation information DB server 21 in response to the information acquisition request 74 is acquired by the information acquisition unit 65 (step ST190). Accordingly, the recommendation information 25 according to the estimated future event is selected. The recommendation information 25 is output from the information acquisition unit 65 to the distribution control unit 66.

Under the control of the distribution control unit 66, the recommendation information 25 is distributed to the user terminal 11, which is the transmission source of the recommendation information distribution request 70 (step ST200).

In the user terminal 11, as shown in FIG. 17, the distributed recommendation information 25 is displayed and is provided for browsing by the user 13. The user 13 makes a plan to go to the store or facility of the recommendation information 25, or considers purchasing the product of the recommendation information 25.

As described above, the CPU 42A of the image management server 10 comprises the estimation unit 64, the information acquisition unit 65, and the distribution control unit 66. In a case where a plurality of images 22, in the images 22 obtained by the user 13 within the set period, that are bases for estimating the future event that the user 13 may experience after the set period are equal to or larger than the first threshold value set in advance, the estimation unit 64 estimates that the user 13 experiences the future event after the set period. The information acquisition unit 65 selects the recommendation information 25 according to the estimated future event from the plurality of pieces of recommendation information 25 registered in advance in the recommendation information DB 24 to generate the recommendation information 25 according to the estimated future event. The distribution control unit 66 distributes the recommendation information 25 to the user terminal 11 to present the recommendation information 25 to the user 13. Therefore, it is possible to present the recommendation information 25 that is likely to be of interest to the user 13 without causing the user 13 to take time and effort to register the schedule information as in the technique described in JP2002-041537A.

For example, a case is considered in which an elder brother is about to get married and a younger sister who does not plan to get married images a state of her brother's Yuino. In this case, the number of sheets of the image 22 that is the basis for estimating the future event, among the images 22 owned by the younger sister, is considered to be relatively small. In such a case, in a case where there is even one image 22 that is the basis for estimating the future event with a setting that the user 13 is estimated to experience the future event after the period, an erroneous estimation is made that the younger sister gets married and the recommendation information 25 regarding the marriage is presented to the younger sister who has no plan to get married. However, in the technique of the present disclosure, in a case where the plurality of images 22 that are the bases for estimating the future event are equal to or larger than the first threshold value, the user 13 is estimated to experience the future event after the period and thus it is possible to reduce the possibility of making the erroneous estimation. As a result, it is possible to suppress the occurrence of inconvenience such as presenting the misguided recommendation information 25 and thus missing a business opportunity.

The estimation unit 64 determines whether or not the image 22 is the basis for estimating the future event, based on the content analysis information 72. Therefore, it is possible to determine whether or not the image 22 is the basis for estimating the future event without causing the user 13 to take time and effort.

The information acquisition unit 65 selects the recommendation information 25 according to the estimated future event from the plurality of pieces of recommendation information 25 registered in advance in the recommendation information DB 24. Therefore, it is possible to easily generate the recommendation information 25.

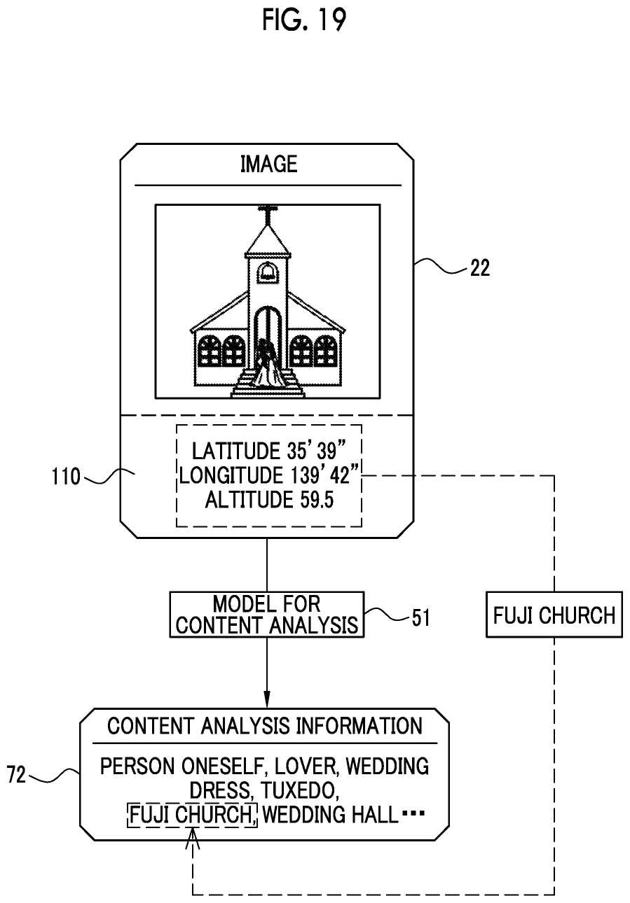

An aspect shown in FIG. 19 may be applied. As shown in FIG. 19 as an example, in the present aspect, an imaging location is specified from imaging position information 110 attached to the image 22, and a name of the store or facility of the specified imaging location is included in the content analysis information 72. The imaging position information 110 is, for example, a longitude and latitude and an altitude acquired by a global positioning system (GPS) function mounted on the user terminal 11. The imaging position information 110 is an example of “information attached to image” according to the technique of the present disclosure. FIG. 19 shows an example in which the content analysis information 72 includes a name “Fuji church” of a facility of the imaging location specified from the imaging position information 110 in the image 22 obtained by capturing a state of the pre-imaging.

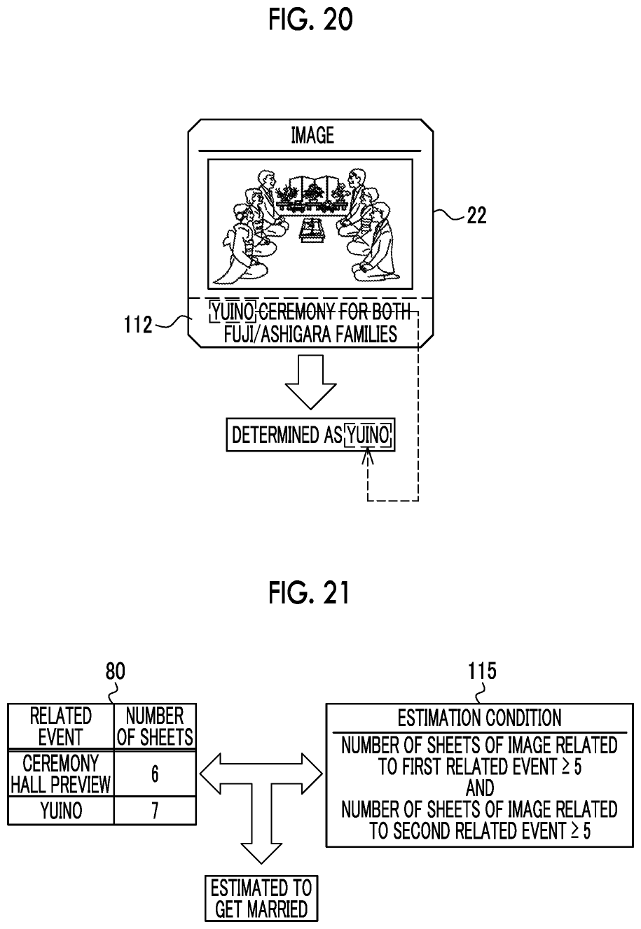

Further, an aspect shown in FIG. 20 may be applied. As shown in FIG. 20 as an example, in the present aspect, determination is made whether or not the image 22 is the basis for estimating a future event, based on tag information 112 attached to the image 22. The tag information 112 is a word representing the content of the image 22. The tag information 112 is input by, for example, the user 13 operating the input device 45B of the user terminal 11. Similarly to the imaging position information 110, the tag information 112 is an example of “information attached to image” according to the technique of the present disclosure. FIG. 20 illustrates a case where the estimation unit 64 determines that the event shown in the image 22 is “Yuino” based on the “Yuino ceremony for both Fuji/Ashigara families” registered in the tag information 112. The word of the content analysis information 72 may be registered as the tag information 112.

As shown in FIGS. 19 and 20, determination may be made whether or not the image 22 is the basis for estimating the future event based on the information attached to the image 22 such as the imaging position information 110 and the tag information 112, in addition to or instead of the content analysis information 72 output by the model for content analysis 51. In this manner, it is possible to increase the reliability of the determination as to whether or not the image 22 is the basis for estimating the future event. Further, in a case where the tag information 112 is used, the model for content analysis 51 and the estimated reference information 52 are not required.

The information attached to the image may be imaging date and time information. For example, the image 22 captured within a period based on an imaging date and time of the image 22 determined to show the related event “Yuino” based on the content analysis information 72 or the tag information 112 is determined to be the image 22 showing unconditionally the related event “Yuino”.

### Second Embodiment

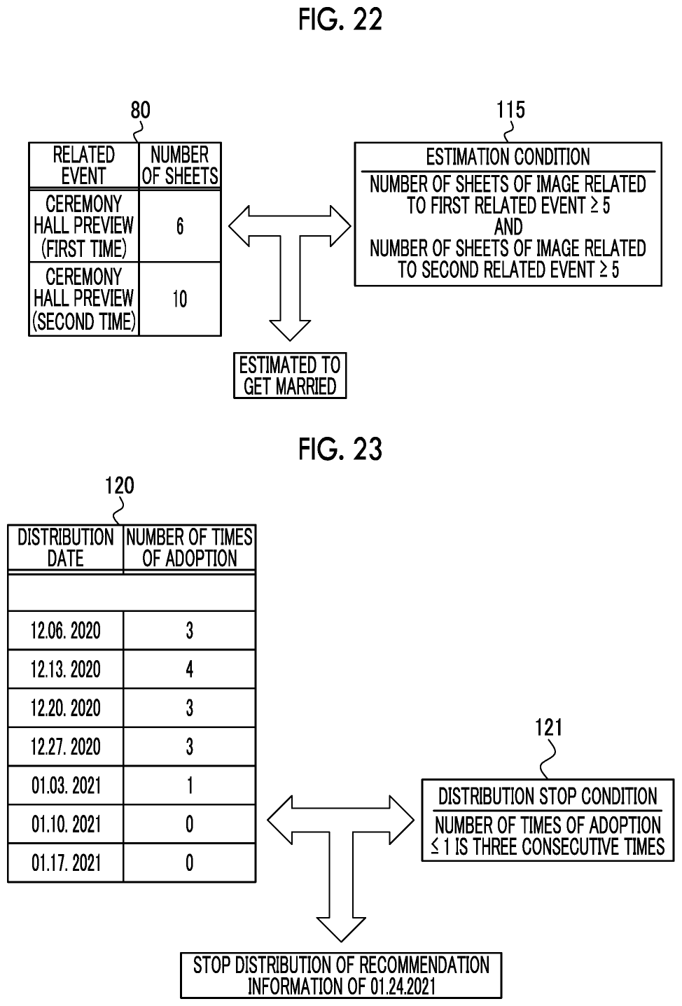

In the first embodiment described above, in a case where the total number of sheets of the image 22 that is the basis for estimating the future event is equal to or larger than the first threshold value, the user 13 is estimated to experience the future event after the set period. However, the present disclosure is not limited thereto. The estimation may be made as in a second embodiment shown in FIGS. 21 and 22.

As shown in FIGS. 21 and 22 as an example, in the second embodiment, an estimation condition 115 for specific related events, which are two of a plurality of related events, is prepared. That is, the estimation condition 115 has a content that the number of sheets of the image 22 related to a first related event, which is one of the specific related events, is equal to or larger than a second threshold value and the number of sheets of the image 22 related to a second related event, which is one of the specific related events, is equal to or larger than the second threshold value. FIGS. 21 and 22 illustrate a case where the second threshold value is five (estimation condition: number of sheets of image 22 related to first related event ≤5 and number of sheets of image 22 related to second related event ≤5).

In a case where the number of sheets of the image 22 related to the first related event and the number of sheets of the image 22 related to the second related event are both equal to or larger than the second threshold value, the estimation unit 64 estimates that the user 13 experiences the future event after the set period.

FIG. 21 illustrates a case where there are six images 22 determined to show the related event “ceremony hall preview” and seven images 22 determined to show the related event “Yuino”, and the user 13 is estimated to get married after the set period. In this case, the related event “ceremony hall preview” and the related event “Yuino” are examples of the “specific related event” according to the technique of the present disclosure.

FIG. 22 illustrates a case where there are six images 22 determined to show the related event “ceremony hall preview (first time)” and ten images 22 determined to show the related event “ceremony hall preview (second time)”, and the user 13 is estimated to get married after the set period. In this case, the related event “ceremony hall preview (first time)” and the related event “ceremony hall preview (second time)” are examples of the “specific related event” according to the technique of the present disclosure. As is clear from the example of FIG. 22, the first related event and the second related event may be the same.

As described above, in the second embodiment, in a case where both of the images 22 related to the two specific related events are equal to or larger than the second threshold value set in advance, the estimation unit 64 estimates that the user 13 experiences the future event after the set period. Therefore, it is possible to further reduce the possibility of making an erroneous estimation.

The specific related event is not limited to the two related events of the first related event and the second related event. The related event may be three or more. Further, the second threshold value may not be the same value uniformly in a plurality of specific related events. For example, the second threshold value for the image 22 related to the first related event may be set to 3, and the second threshold value for the image 22 related to the second related event may be set to 5.

### Third Embodiment

As shown in FIG. 23 as an example, in a third embodiment, the number of times the user 13 adopts the recommendation information 25 is totaled for each distribution date of the recommendation information 25 in the image management server 10, as shown in a table 120. The number of times of adoption is, for example, the number of times that the user 13 selects the recommendation information 25 in order to display the entire content of the recommendation information 25 in an enlarged manner in the list 98. The number of times of adoption is an example of the “frequency of adoption” according to the technique of the present disclosure.

The distribution control unit 66 determines whether or not to stop the distribution of the recommendation information 25 based on a distribution stop condition 121. The distribution stop condition 121 is, for example, a content that the distribution date in which the number of times of adoption is equal to or less than a third threshold value is three consecutive times. The distribution control unit 66 stops the distribution of the recommendation information 25 on a next distribution date in a case where the distribution date in which the number of times of adoption is equal to or less than the third threshold value is three consecutive times.

FIG. 23 illustrates a case where the third threshold value is 1 (distribution stop condition: number of times of adoption <1 is three consecutive times). Further, FIG. 23 illustrates a case where the number of times of adoption is “1”, “0”, and “0” on distribution dates “2021.01.03”, “2021.01.10”, and “2021.01.17”, respectively, the number of times of adoption is 1 or less for three consecutive times, and the distribution of the recommendation information 25 on a distribution date “2021.01.24” is stopped.

As described above, in the third embodiment, in a case where the number of times the user 13 adopts the recommendation information 25 satisfies the distribution stop condition 121 set in advance, the presentation of the recommendation information 25 is stopped. Therefore, it is possible to prevent the user 13 from unnecessarily distributing the recommendation information 25 that is considered to have lost interest after the user 13 has already experienced the future event.

The number of times of adoption may be the number of times the product of the recommendation information 25 is purchased. Further, the frequency of adoption may be an average of the number of times of adoption on each distribution date. In this case, the distribution stop condition is, for example, a content that the distribution date on which the average of the number of times of adoption is equal to or less than the third threshold value is three consecutive times.

[4_1st Embodiment]

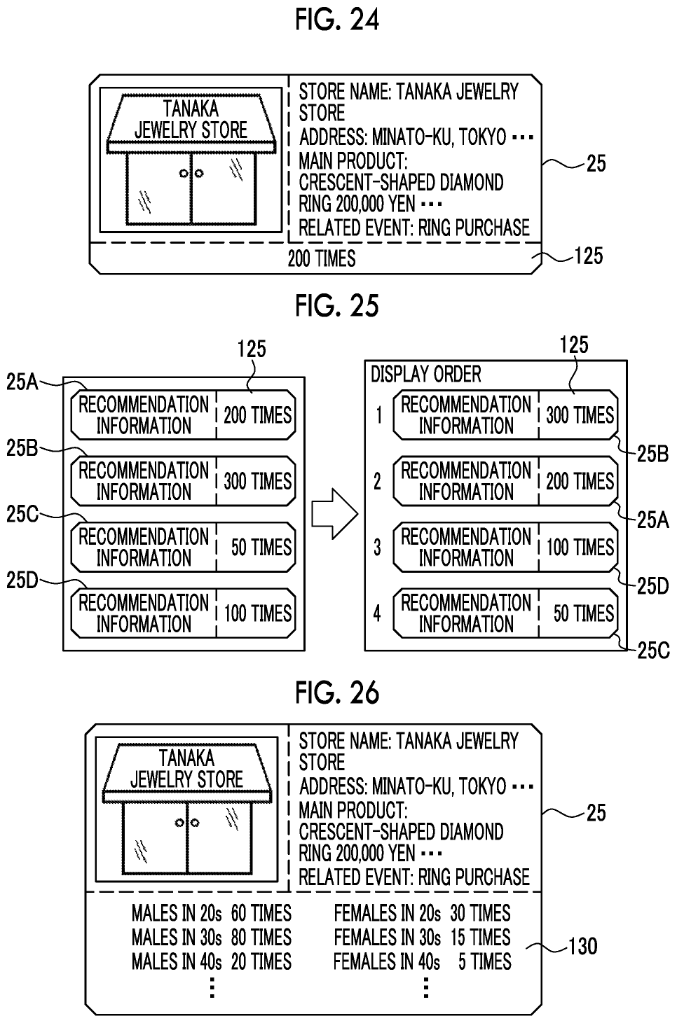

As shown in FIG. 24 as an example, in a 4_1st embodiment, the recommendation information 25 is used in which the cumulative number of times of adoption 125 is registered. The cumulative number of times of adoption 125 is the cumulative number of times each user 13 selects the recommendation information 25 in order to display the entire content of the recommendation information 25 in an enlarged manner in the list 98. FIG. 24 illustrates the recommendation information 25 in which “200 times” is registered as the cumulative number of times of adoption 125.

As shown in FIG. 25 as an example, the distribution control unit 66 sets a display order in the list 98 of the plurality of pieces of recommendation information 25 from the information acquisition unit 65 in descending order of the cumulative number of times of adoption 125. With the setting of the display order in descending order of the cumulative number of times of adoption 125 in this manner, the distribution control unit 66 preferentially presents the recommendation information 25 that is relatively frequently adopted by another user 13. The distribution control unit 66 distributes the set display order and the recommendation information 25 to the user terminal 11, which is the transmission source of the recommendation information distribution request 70. The browser control unit 90 of the user terminal 11 displays the recommendation information 25 in the list 98 according to the display order.

FIG. 25 shows an example of setting the display order of four pieces of recommendation information 25A to 25D of recommendation information 25A where the cumulative number of times of adoption 125 is “200 times”, recommendation information 25B where the cumulative number of times of adoption 125 is “300 times”, recommendation information 25C where the cumulative number of times of adoption 125 is “50 times”, and recommendation information 25D where the cumulative number of times of adoption 125 is “100 times”. In this case, the distribution control unit 66 sets the display order of the recommendation information 25B, the recommendation information 25A, the recommendation information 25D, and the recommendation information 25C in this order.

As described above, in the 4_1st embodiment, the recommendation information 25 that is relatively frequently adopted by another user 13 is preferentially presented. The recommendation information 25 that is relatively frequently adopted by another user 13 is the recommendation information 25 of a hot-selling product in a case where the recommendation information 25 is related to the product, and is the recommendation information 25 of a popular store or facility in a case where the recommendation information 25 is related to the store or facility. Therefore, the distribution control unit 66 can preferentially present the recommendation information 25 that is more useful to the user 13.

[4_2nd Embodiment]

As shown in FIG. 26 as an example, in a 4_2nd embodiment, the recommendation information 25 is used in which the cumulative number of times of adoption 130 for each attribute of the user 13 is registered. The attribute of the user 13 is a combination of the age and the gender of the user 13, such as “males in 20s” and “females in 40s”. The age of the user 13 can be deduced from the date of birth of the attribute information 31. FIG. 26 illustrates the recommendation information 25 in which “60 times” is registered as the cumulative number of times of adoption 130 of males in 20s, “15 times” is registered as the cumulative number of times of adoption 130 of females in 30s, and the like. In a case where the date of birth is not registered in the attribute information 31, the age of the user 13 may be estimated from the face image 32.

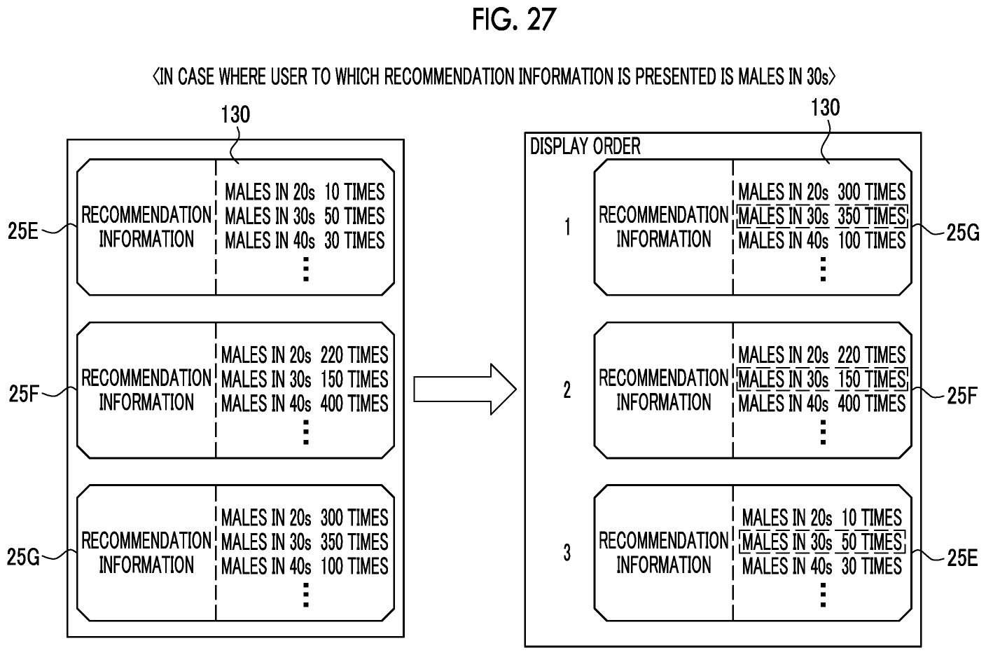

As shown in FIG. 27 as an example, the distribution control unit 66 sets the display order in the list 98 of the plurality of pieces of recommendation information 25 from the information acquisition unit 65 in descending order of the cumulative number of times of adoption 130 for the attribute matching the user 13 to which the recommendation information is presented. With the setting of the display order in descending order of the cumulative number of times of adoption 130 for the attribute matching the user 13 to which the recommendation information 25 is presented in this manner, the distribution control unit 66 preferentially presents the recommendation information 25 that is relatively frequently adopted by a user 13 whose attribute matches that of the user 13 to which the recommendation information 25 is presented. The distribution control unit 66 distributes the set display order and the recommendation information 25 to the user terminal 11, which is the transmission source of the recommendation information distribution request 70. The browser control unit 90 of the user terminal 11 displays the recommendation information 25 in the list 98 according to the display order.

FIG. 27 illustrates a case where the user 13 to which the recommendation information is presented is males in 30s. Further, FIG. 27 shows an example of setting the display order of three pieces of recommendation information 25E to 25G of recommendation information 25E where the cumulative number of times of adoption 130 of males in 30s is “50 times”, recommendation information 25F where the cumulative number of times of adoption 130 of males in 30s is “150 times”, and recommendation information 25G where the cumulative number of times of adoption 130 of males in 30s is “350 times”. In this case, the distribution control unit 66 sets the display order of the recommendation information 25G, the recommendation information 25F, and the recommendation information 25E in this order.

As described above, in the 4_2nd embodiment, “another user” according to the technique of the present disclosure is the user 13 whose attribute matches that of the user 13 to which the recommendation information 25 is presented. Therefore, the distribution control unit 66 can preferentially present the recommendation information 25 that is widely adopted by the user 13 whose attribute matches that of the user oneself

The residential area, the family structure, and the like may be included in the attribute for which the cumulative number of times of adoption 130 is registered. Further, the attribute for which the cumulative number of times of adoption 130 is registered may be the age of the user 13 at five-year intervals, such as 20 years old, 25 years old, 30 years old, . . . . In this case, the user 13 to which the recommendation information 25 is presented may be an age that is not included in the attribute, such as 23 years old. In such a case, the cumulative number of times of adoption 130 that is closer to the age at five-year intervals is used. For example, in a case where the age of the user 13 to which the recommendation information 25 is presented is 34 years old, the cumulative number of times of adoption 130 of 35 years old among the cumulative number of times of adoption 130 of 30 years old and the cumulative number of times of adoption 130 of 35 years old is used. That is, “another user” according to the technique of the present disclosure may be the user 13 whose attribute is similar to that of the user 13 to which the recommendation information 25 is presented.

[4_3rd Embodiment]

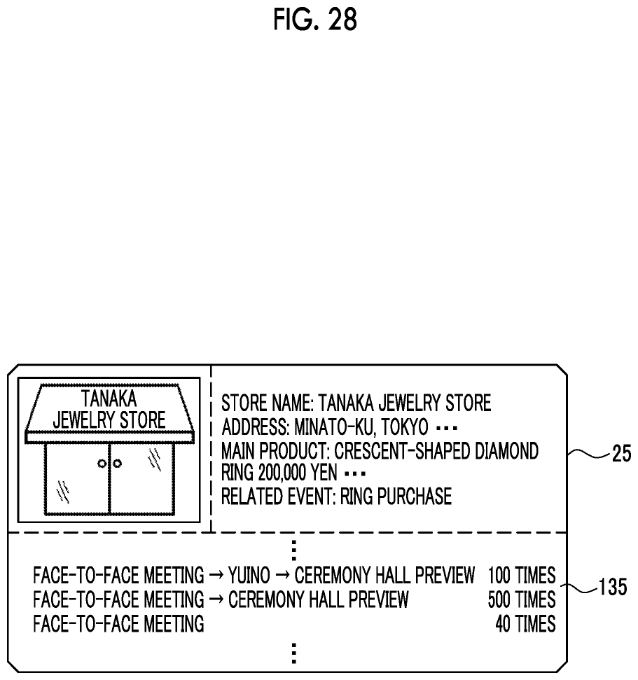

As shown in FIG. 28 as an example, in a 4_3rd embodiment, the recommendation information 25 is used in which the cumulative number of times of adoption 135 for each event experience order of the user 13 is registered. The event experience order of the user 13 is the order of related events experienced by the user 13, for example, “face-to-face meeting→Yuino→ceremony hall preview”. The order of the related events can be obtained by arranging the related events determined by the estimation unit 64 based on the estimated reference information 52 and the content analysis information 72 in a time series with reference to the imaging date and time information of the image 22. FIG. 28 illustrates the recommendation information 25 in which “100 times” is registered as the cumulative number of times of adoption 135 for the event experience order of “face-to-face meeting→Yuino→ceremony hall preview”, “40 times” is registered as the cumulative number of times of adoption 135 for the event experience order of only “face-to-face meeting”, and the like.

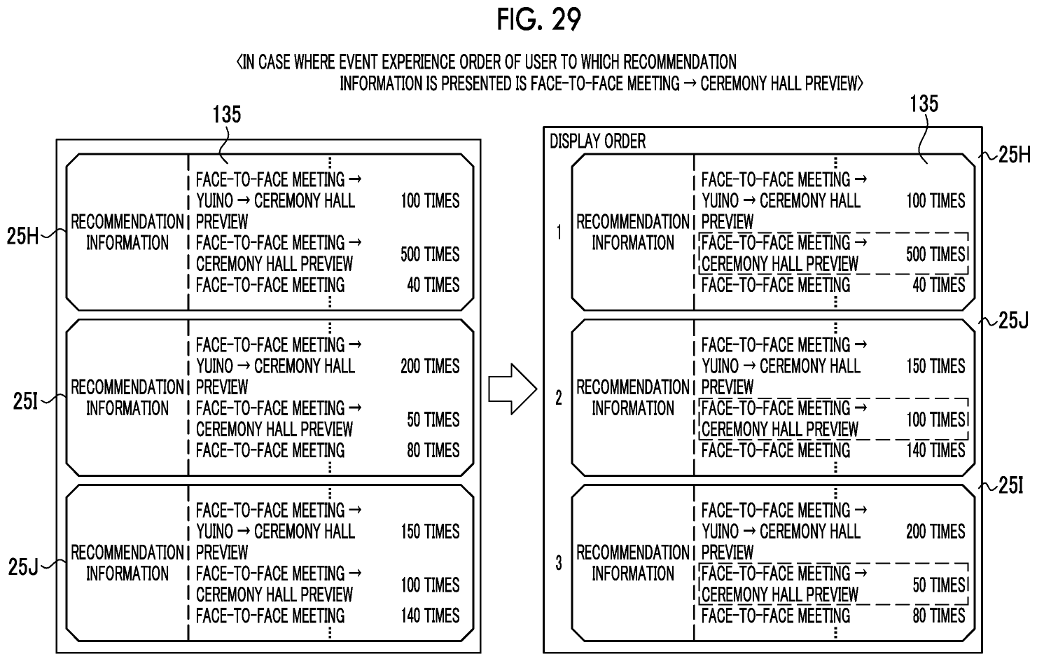

As shown in FIG. 29 as an example, the distribution control unit 66 sets the display order in the list 98 of the plurality of pieces of recommendation information 25 from the information acquisition unit 65 in descending order of the cumulative number of times of adoption 135 for the event experience order matching the user 13 to which the recommendation information 25 is presented. With the setting of the display order in descending order of the cumulative number of times of adoption 135 for the event experience order matching the user 13 to which the recommendation information 25 is presented in this manner, the distribution control unit 66 preferentially presents the recommendation information 25 that is relatively frequently adopted by a user 13 whose event experience order matches that of the user 13 to which the recommendation information 25 is presented. The distribution control unit 66 distributes the set display order and the recommendation information 25 to the user terminal 11, which is the transmission source of the recommendation information distribution request 70. The browser control unit 90 of the user terminal 11 displays the recommendation information 25 in the list 98 according to the display order.

FIG. 29 illustrates a case where the event experience order of the user 13 to which the recommendation information 25 is presented is “face-to-face meeting→ceremony hall preview”. Further, FIG. 29 shows an example of setting the display order of three pieces of recommendation information 25H to 25J of recommendation information 25H where the cumulative number of times of adoption 135 for the event experience order of “face-to-face meeting→ceremony hall preview” is “500 times”, recommendation information 25I where the cumulative number of times of adoption 135 for the event experience order of “face-to-face meeting→ceremony hall preview” is “50 times”, and recommendation information 25J where the cumulative number of times of adoption 135 for the event experience order of “face-to-face meeting→ceremony hall preview” is “100 times”. In this case, the distribution control unit 66 sets the display order of the recommendation information 25H, the recommendation information 25J, and the recommendation information 25I in this order.

As described above, in the 4_3rd embodiment, “another user” according to the technique of the present disclosure is the user 13 whose event experience order matches that of the user 13 to which the recommendation information 25 is presented. Therefore, the distribution control unit 66 can preferentially present the recommendation information 25 that is widely adopted by the user 13 whose event experience order matches that of the user oneself.

The event experience order for which the cumulative number of times of adoption 135 is registered may be narrowed down to a few representative types. In this case, the event experience order of the user 13 to which the recommendation information 25 is presented may not match the representative event experience order. In such a case, the cumulative number of times of adoption 135 for the representative event experience order similar to the event experience order of the user 13 to which the recommendation information 25 is presented is used. For example, in a case where the event experience order of the user 13 to which the recommendation information 25 is presented is “face-to-face meeting→Yuino→ceremony hall preview→costume fitting” and there is no event experience order that matches this event experience order, the cumulative number of times of adoption 135 for the representative event experience order of “face-to-face meeting→Yuino→ceremony hall preview→costume fitting→pre-imaging” is used. That is, “another user” according to the technique of the present disclosure may be the user 13 whose event experience order is similar to that of the user 13 to which the recommendation information 25 is presented.

The method of preferentially presenting the recommendation information 25 that is relatively frequently adopted by another user 13 is not limited to the illustrated method of setting the display order in the list 98 in descending order of the cumulative number of times of adoption 125, 130, or 135. A method may be used such that a display mode is employed in which the cumulative number of times of adoption 125, 130, or 135 is more conspicuous than the recommendation information 25, which is relatively small, with distribution, to the user terminal 11, of only the recommendation information 25 in which the cumulative number of times of adoption 125, 130, or 135 is equal to or larger than a threshold value set in advance, with display of a blinking frame for the recommendation information 25 in which the cumulative number of times of adoption 125, 130, or 135 is relatively large, or the like.

Similarly to the number of times of adoption in the third embodiment, the cumulative number of times of adoption 125 may be the number of times the product of the recommendation information 25 is purchased. Further, instead of the cumulative number of times of adoption 125, the monthly average number of times of adoption may be registered.

The above 4_2nd and 4_3rd embodiments may be combined and implemented. That is, the recommendation information 25 is used in which the cumulative number of times of adoption is registered for each attribute of the user 13 and for each event experience order of the user 13. The recommendation information 25 that is relatively frequently adopted by the user whose attribute and event experience order are similar to or match those of the user 13 to which the recommendation information 25 is presented is preferentially presented.

In each of the above embodiments, the “marriage” is illustrated as the future event, but the present disclosure is not limited thereto.

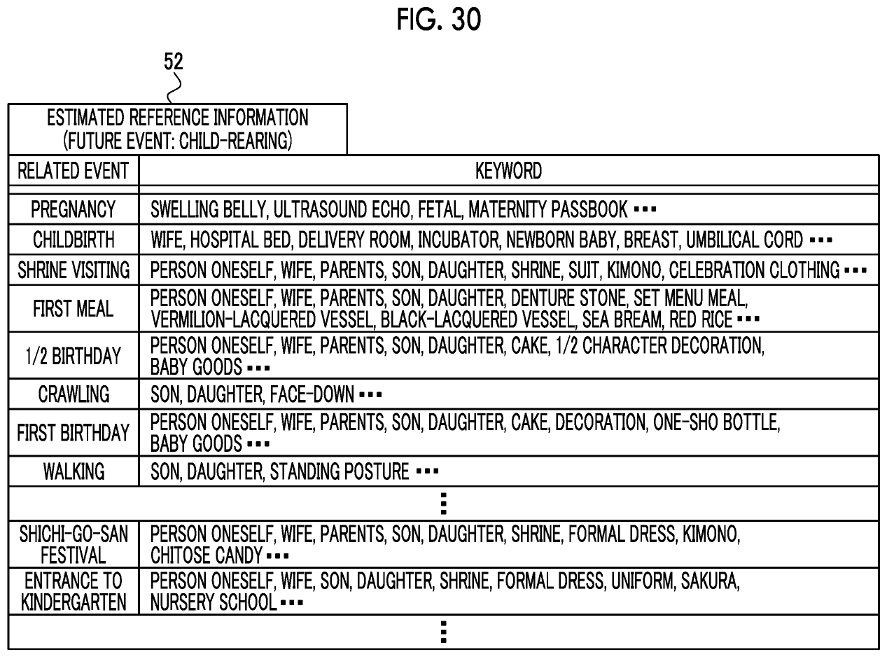

FIG. 30 shows an example of the estimated reference information 52 of a future event “child-rearing”. Examples of the related event in this case include “pregnancy”, “childbirth”, “shrine visiting”, “first meal”, “1/2 birthday”, “shichi-go-san festival”, and “entrance to kindergarten”. Further, examples of the keyword include “swelling belly, ultrasound echo, fetal, maternity passbook,” in the related event “pregnancy” and “person oneself, wife, parents, son, daughter, shrine, formal dress, kimono, Chitose candy,” in the related event “shichi-go-san festival”. In this case, as the recommendation information 25 of product, the image management server 10 presents, to the user 13, maternity goods, a baby bottle, milk, an infant toy, a celebration dress for shrine visiting, a rental kimono for shichi-go-san festival, and the like. Further, as the recommendation information 25 of store or facility, the user 13 is presented with a maternity classroom, a baby goods store, a nursery school, a toy store, and the like.

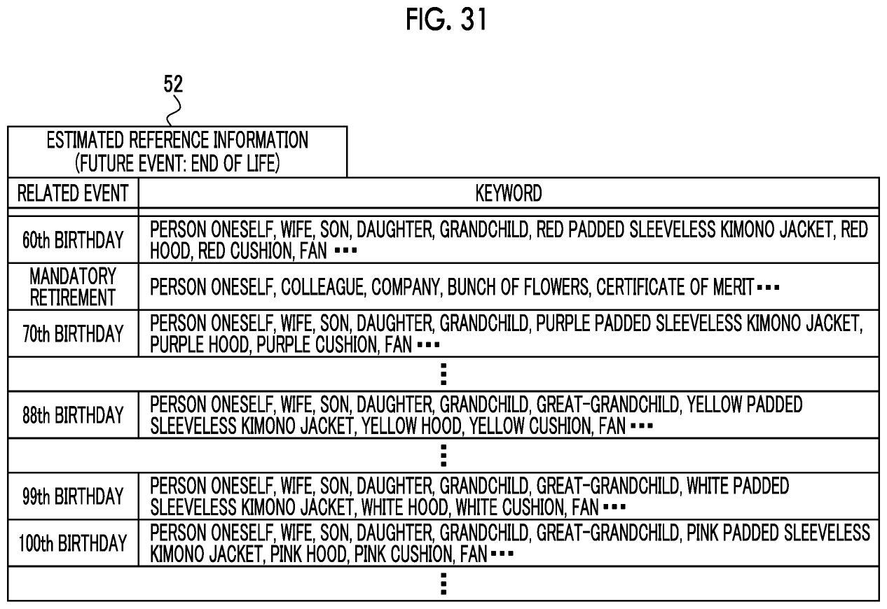

FIG. 31 shows an example of the estimated reference information 52 of a future event “end of life”. Examples of the related event in this case include “60th birthday”, “mandatory retirement”, “70th birthday”, “88th birthday”, “99th birthday”, and “100th birthday”. Further, examples of the keyword include “person oneself, wife, son, daughter, grandchild, purple padded sleeveless kimono jacket, purple hood, purple cushion, fan,” in the related event “70th birthday” and “person oneself, wife, son, daughter, grandchild, great-grandchild, pink padded sleeveless kimono jacket, pink hood, pink cushion, fan,” in the related event “100th birthday”. In this case, as the recommendation information 25 of product, the image management server 10 presents, to the user 13, ground golf equipment, reading glasses, a cane, and the like. Further, as recommendation information 25 of store or facility, the user 13 is presented with a Go salon, a social dance circle, a travel company that holds a pack trip for seniors, arrangement for funeral, a facility or the like that holds a so-called end-of-life briefing session such as distribution of property, and the like. Paying attention to the fact that many users 13 who digitize the image captured in the photographic film in the past are elderly, the digitized image 22 may be determined to be the image 22 that is the basis for estimating the future event “end of life”.

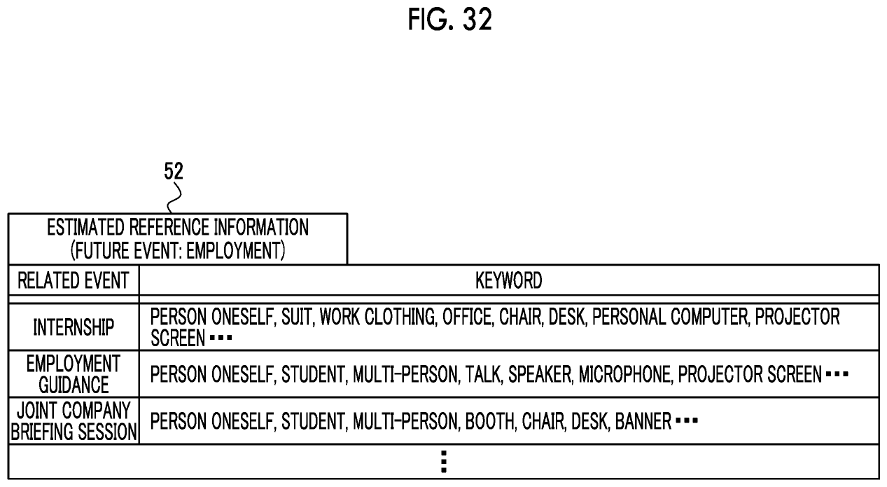

FIG. 32 shows an example of the estimated reference information 52 of the future event “employment”. Examples of the related event in this case include “internship”, “employment guidance”, and “joint company briefing session”. Further, examples of the keyword include “person oneself, suit, work clothing, office, chair, desk, personal computer, projector screen, . . . ” in the related event “internship” and “person oneself, student, multi-person, booth, chair, desk, banner,” in the related event “joint company briefing session”. In this case, as the recommendation information 25 of product, the image management server 10 presents, to the user 13, an employment information magazine, a writing tool, and the like. Further, as the recommendation information 25 of store or facility, the user 13 is presented with a facility where the joint company briefing session is held, an employment examination school where a mock interview is conducted, and the like.

At major milestones in life such as the future events “marriage”, “child-rearing”, and “employment”, relatively expensive products such as a new house, a private car, and a home appliance are often purchased. The image 22 that is the basis for estimating the future event may further include the image 22 obtained by capturing a purchased new house, the image 22 obtained by capturing a moving state, the image 22 obtained by capturing a purchased private car, the image 22 obtained by capturing a purchased home appliance, and the like. Further, in a case where the user 13 is estimated to experience the above future event, the user 13 may be presented with the recommendation information 25 regarding the new house, the moving, the private car, the home appliance, and the like.

A “change in family structure” such that the child becomes independent and there is a married couple of the user 13 living alone, or conversely, the user 13 leaves the parents' home and lives alone may be set as the future event. In this case, paying attention to the fact that many people purchase pets because of loneliness, the image 22 obtained by capturing a purchased pet may be added as the image 22 that is the basis for estimating the future event “change in family structure”. Further, for example, a trip with person oneself, wife, and daughter has been performed, but a person who goes together for trip changes such as increased opportunities to go trip with person oneself and wife due to the daughter getting married and leaving home. Therefore, the image 22 obtained by capturing a state of trip may be added as the image 22 that is the basis for estimating the future event “change in family structure”. As the recommendation information 25 for the future event “change in family structure”, the recommendation information 25 of a pet shop, a travel magazine specializing in a couple's trip, or the like may be presented.

The recommendation information 25 is generated by selecting the recommendation information 25 according to the estimated future event from the plurality of pieces of recommendation information 25 registered in the recommendation information DB 24, but the present disclosure is not limited thereto. The recommendation information 25 according to the estimated future event may be generated by using a machine learning model in which the estimated future event is used as input data and the recommendation information 25 is used as output data.

In the first embodiment and the like, the content analysis information 72 is generated from the image 22 using the model for content analysis 51, and the related event shown in the image 22 is determined from the estimated reference information 52 and the content analysis information 72. However, the present disclosure is not limited thereto. A machine learning model may be used in which the related event shown in the image 22 is output in a case where the image 22 is input.

In the first embodiment and the like, the recommendation information distribution request 70 is transmitted from the user terminal 11 to the image management server 10 for each set period, but the present disclosure is not limited thereto. In a case where the image browsing AP 85 is executed and a web browser dedicated to the image browsing AP 85 is started, the recommendation information distribution request 70 may be transmitted from the user terminal 11 to the image management server 10.

In the first embodiment and the like, the list 98 of the recommendation information 25 is displayed on the image list display screen 95, but the present disclosure is not limited thereto. The list 98 of the recommendation information 25 may be displayed on an independent screen separate from the image list display screen 95.

Various screens such as the image list display screen 95 may be generated in the image management server 10 and distributed to the user terminal 11 in a format of screen data for web distribution created by a markup language such as an extensible markup language (XML). In this case, the browser control unit 90 reproduces the various screens displayed on the web browser based on the screen data and displays the screens on the display 44B. Instead of XML, another data description language such as JavaScript (registered trademark) object notation (JSON) may be used.

The user terminal 11 that transmits the image 22 to the image management server 10 may be separate from the user terminal 11 that receives the distribution of the recommendation information 25 from the image management server 10. For example, in a case where there are a plurality of user terminals 11 having the same account of the user 13, one of the user terminals 11 may transmit the image 22 to the image management server 10 and the recommendation information 25 may be distributed from the image management server 10 to another user terminal.

A form of presenting the recommendation information 25 to the user 13 is not limited to the form of distributing the recommendation information 25 to the user terminal 11. The recommendation information 25 may be printed on a paper medium and the paper medium may be mailed to the user 13, or the recommendation information 25 may be attached to an e-mail to be transmitted.

Various modifications can be made for a hardware configuration of the computer constituting the image management server 10. For example, the image management server 10 may be configured of a plurality of computers separated as hardware for a purpose of improving processing capability and reliability. For example, the functions of the request reception unit 60, the image acquisition unit 61, the information acquisition unit 65, and the distribution control unit 66, and the functions of the RW control unit 62, the analysis unit 63, and the estimation unit 64 are carried by two computers in a distributed manner. In this case, the image management server 10 is configured with two computers. Further, the image management server 10, the image DB server 20, and the recommendation information DB server 21 may be integrated into one server.

As described above, the hardware configuration of the computer of the image management servers 10 may be changed as appropriate according to required performance such as processing capability, safety, and reliability. Further, not only the hardware but also the AP such as the operation program 50, for the purpose of ensuring safety and reliability, may be duplicated or stored in a plurality of storage devices in a distributed manner.

The user terminal 11 may be responsible for a part or all of the functions of each processing unit of the image management server 10.

In each of the above embodiments, for example, the following various processors can be used as a hardware structure of the processing units that execute various pieces of processing, such as the request reception unit 60, the image acquisition unit 61, the RW control unit 62, the analysis unit 63, the estimation unit 64, the information acquisition unit 65, the distribution control unit 66, and the browser control unit 90. The various processors include a programmable logic device (PLD) which is a processor whose circuit configuration is changeable after manufacturing such as a field programmable gate array (FPGA) and/or a dedicated electric circuit which is a processor having a circuit configuration exclusively designed to execute specific processing such as an application specific integrated circuit (ASIC), and the like, in addition to the CPUs 42A and 42B which are general-purpose processors that execute software (operation program 50 and image browsing AP 85) to function as the various processing units.

One processing unit may be configured by one of the various types of processors or may be configured by a combination of two or more processors of the same type or different types (for example, a combination of a plurality of FPGAs and/or a combination of a CPU and an FPGA). The plurality of processing units may be configured of one processor.

As an example of configuring the plurality of processing units with one processor, first, there is a form in which one processor is configured by a combination of one or more CPUs and software and the processor functions as the plurality of processing units, as represented by computers such as a client and a server. Second, there is a form in which a processor that realizes the functions of the entire system including the plurality of processing units with one integrated circuit (IC) chip is used, as represented by a system-on-chip (SoC) or the like. As described above, the various processing units are configured using one or more of the various processors as the hardware structure.

More specifically, a circuitry combining circuit elements such as semiconductor elements may be used as the hardware structure of the various processors.

The above various embodiments and/or various modification examples can be combined as appropriate in the technique of the present disclosure. It is needless to say that the technique of the present disclosure is not limited to each of the above embodiments and various configurations can be employed without departing from the gist. Further, the technique of the present disclosure extends to a storage medium that stores the program non-transitorily, in addition to the program.

The description content and the illustrated content described above are detailed descriptions of portions according to the technique of the present disclosure and are merely an example of the technique of the present disclosure. For example, the above description of the configurations, functions, actions, and effects is an example of the configurations, functions, actions, and effects of the portions according to the technique of the present disclosure. Therefore, it is needless to say that an unnecessary part may be deleted, a new element may be added, or a replacement may be performed to the description content and the illustrated content described above within a scope not departing from the gist of the technique of the present disclosure. In order to avoid complication and facilitate understanding of the portion according to the technique of the present disclosure, the description related to common general knowledge not requiring special description in order to implement the technique of the present disclosure is omitted in the above description content and illustrated content.

In the present specification, “A and/or B” is synonymous with “at least one of A or B”. That is, “A and/or B” means that only A may be used, only B may be used, or a combination of A and B may be used. In the present specification, the same concept as “A and/or B” is also applied to a case where three or more matters are linked and expressed by “and/or”.

All documents, patent applications, and technical standards described in this specification are incorporated by reference in this specification to the same extent as in a case where the incorporation of each individual document, patent application, and technical standard by reference is specifically and individually described.

What is claimed is:

1. A recommendation information presentation device comprising:
a processor; and
a memory connected to or built into the processor,
wherein the processor
estimates, in a case where a plurality of images, among images obtained by a user within a period set in advance, that are bases for estimating a future event that the user is expected to experience after the period are equal to or larger than a first threshold value set in advance, that the user experiences the future event after the period,
generates recommendation information according to the estimated future event, and
presents the recommendation information to the user.

2. The recommendation information presentation device according to claim 1,
wherein the processor determines whether or not the image is the basis for estimating the future event based on at least any one of an analysis result of the image or information attached to the image.

3. The recommendation information presentation device according to claim 1,
wherein the processor estimates, in a case where all images related to specific related events, which are at least two of related events which are events related to the future event, are equal to or larger than a second threshold value set in advance, that the user experiences the future event after the period.

4. The recommendation information presentation device according to claim 1,
wherein the processor stops, in a case where a frequency of adoption of the recommendation information by the user satisfies a condition set in advance, the presentation of the recommendation information.

5. The recommendation information presentation device according to claim 1,
wherein the processor preferentially presents the recommendation information that is relatively frequently adopted by another user.

6. The recommendation information presentation device according to claim 5,
wherein the other user is a user whose attribute is similar to or matches an attribute of the user to which the recommendation information is presented.

7. The recommendation information presentation device according to claim 5,
wherein the other user is a user whose event experience order is similar to or matches an event experience order of the user to which the recommendation information is presented.

8. The recommendation information presentation device according to claim 1,
wherein the processor selects the recommendation information according to the estimated future event from a plurality of pieces of the recommendation information registered in advance.

9. An operation method of a recommendation information presentation device comprising:
estimating, in a case where a plurality of images, among images obtained by a user within a period set in advance, that are bases for estimating a future event that the user is expected to experience after the period are equal to or larger than a first threshold value set in advance, that the user experiences the future event after the period;
generating recommendation information according to the estimated future event; and
presenting the recommendation information to the user.

10. A non-transitory computer-readable storage medium storing an operation program of a recommendation information presentation device that causes a computer to execute a process comprising:
estimating, in a case where a plurality of images, among images obtained by a user within a period set in advance, that are bases for estimating a future event that the user is expected to experience after the period are equal to or larger than a first threshold value set in advance, that the user experiences the future event after the period;
generating recommendation information according to the estimated future event; and
presenting the recommendation information to the user.
